(19) United States
(12) Patent Application Publication
(10) Pub. No.: US 2026/0346482 A1
(43) Pub. Date: Nov. 5, 2026

(54) COOLING OF ARTIFICIAL MUSCLE

(71) Applicant: The University of Western Ontario, London, Ontario (CA)

(72) Inventors: Ana Luisa TREJOS, London, Ontario (CA); Alex Taylor LIZOTTE, London, Ontario (CA); Brandon EDMONDS, London, Ontario (CA); Parisa DAEMI, London, Ontario (CA); Christopher DEGROOT, London, Ontario (CA)

(21) Appl. No.: 19/104,913

(22) PCT Filed: Aug. 18, 2023
(86) PCT No.: PCT/CA2023/000021

§ 371 Date: Feb. 19, 2025

Related U.S. Application Data
(60) Provisional application No. 63/373,011, filed on Aug. 19, 2022.

(51) Int. Cl. B25J 19/00; B25J 9/10

(52) U.S. Cl. CPC B25J 19/0054; B25J 9/1075

(57) ABSTRACT

A cooling system for an artificial muscle, including: a flexible channel of tubular shape defining a lumen bound by a first end and a second end; an inlet interface attached to the first end of the flexible channel, at least a first port disposed in the inlet interface; an outlet formed by an opening at the second end of the flexible channel; an air flow device communicative with the at least first port disposed in the inlet interface.

### BACKGROUND OF THE INVENTION

### Field of the Invention

The present invention relates to artificial muscles, and more particularly to cooling of thermally activated artificial muscles.

### Description of the Related Art

Actuators are needed in robotics applications. Robotic devices and, more particularly wearable robotic devices, are an active area of development for rehabilitation. For example, development of robotic devices to assist with physiotherapy, support activities of daily living, suppress tremor in Parkinson's Disease have been contemplated. In a further example, robotic rehabilitation has been demonstrated to be effective for stroke rehabilitation.

Robotic devices are not common due to their high cost and limited portability, which stems in part, from using electric motors as the primary actuator. One method to reduce the cost and increase the portability of wearable robotic devices is to use alternative actuators, such as artificial muscles. Artificial muscles are lightweight and inexpensive compared electric motors. Artificial muscles have additional advantages of being biomimetic and compliant, which reduces the chance of injury to the user.

Thermally activated artificial muscles are a type of artificial muscles characterized by transitioning from an equilibrium or neutral state to an activated state upon heating. Typically, the equilibrium or neutral state corresponds to a fully extended position of the axial length of the thermally activated artificial muscle and the activated state corresponds to a contracted position of the axial length of the thermally activated artificial muscle. Some examples are configured differently, in that the equilibrium or neutral state corresponds to a fully contracted position of the axial length of the thermally activated artificial muscle and the activated state corresponds to a extended position of the axial length of the thermally activated artificial muscle. A limitation for employing thermally activated artificial muscles in wearable robotic devices is that bandwidth obtained with passive cooling is too slow to support rehabilitation exercises or voluntary motion.

Active cooling of thermally activated artificial muscles has been tested in four environments: forced air, still air, hydrogel, and water. It was found that the water and hydrogel environments offered the fastest cooling times, but the hydrogel had a limited life time (up to 30 actuation cycles) and the water decreased the efficiency of the artificial muscle during heating. In another example of active cooling, encasing a thermally activated artificial muscle in a rigid plastic tube to direct the air flow was found to be an effective cooling method. However, a rigid plastic tube is difficult to embed in soft wearable robotic systems.

Accordingly, there is a continuing need for alternative devices, systems and methods for cooling artificial muscles.

### SUMMARY OF THE INVENTION

In an aspect there is provided, a cooling system for an artificial muscle, comprising: a flexible channel of tubular shape defining a lumen bound by a first end and a second end; an inlet interface attached to the first end of the flexible channel, at least a first port disposed in the inlet interface; an outlet formed by an opening at the second end of the flexible channel; an air flow device communicative with the at least first port disposed in the inlet interface.

In further aspects methods for cooling artificial muscles are also provided.

### BRIEF DESCRIPTION OF THE DRAWINGS

FIG. 1 shows an isometric view of an example of a cooling system for cooling artificial muscle.

FIG. 2 shows an elevational view of the cooling system shown in FIG. 1.

FIG. 3A shows an isometric view of a flexible channel isolated from the cooling system shown in FIG. 1. FIG. 3B shows an elevational view of a modular inlet interface attached to a first end of the flexible channel shown in FIG. 3A.

FIG. 4A shows an isometric view of a central piece of the modular inlet interface shown in FIG. 3B. FIG. 4B shows an elevational view of the central piece of the modular inlet interface shown in FIG. 3B.

FIG. 5A shows an isometric view of a circumferential piece of the modular inlet interface shown in FIG. 3B. FIG. 5B shows an elevational view of the circumferential piece of the modular inlet interface shown in FIG. 3B.

FIG. 6A shows a first variant of the flexible channel shown in FIG. 3A. FIG. 6B shows an elevational view of a modular inlet interface attached to a first end of the first variant flexible channel shown in FIG. 6A.

FIG. 7A shows a second variant of the flexible channel shown in FIG. 3A. FIG. 7B shows an elevational view of a center piece of the inlet interface attached to a first end of the second variant flexible channel shown in FIG. 7A.

FIG. 8A shows a third variant of the flexible channel shown in FIG. 3A. FIG. 8B shows an elevational view of a center piece of the inlet interface attached to a first end of the flexible channel shown in FIG. 8A.

FIG. 9 shows the model of a TCA and fabric channel in (FIG. 9A) Fluent and (FIG. 9B) CAD in Experimental Example 1.

FIG. 10 shows meshes tested in the grid independence test in Experimental Example 1; left is Mesh 1 and right is Mesh 2.

FIG. 11 shows temperature vs. time plots for all inputs velocities in Experimental Example 1. The grey horizontal line marks the temperature at which the time constant was measured (58.4 °C).

FIG. 12 shows TCA cooling time constant vs. input velocity with a line of best fit of τ=11.02 Vᵢₙ^{-0.58} in Experimental Example 1.

FIG. 13 shows a comparison of simulation results with experimental data in Experimental Example 1.

FIG. 14 shows, for Experimental Example 2, (FIG. 14A) an inlet design in CAD, (FIG. 14B) printed with different sized covers, (FIG. 14C) with the components connected, and (FIG. 14D) in a channel.

FIG. 15 shows a channel fabrication procedure (steps A to G) in Experimental Example 2.

FIG. 16 shows a design of the cooling apparatus in Experimental Example 2: the design consists of a fabric channel to house the TCA with a miniature air pump connected to the channel with a flexible plastic tube.

FIG. 17 shows an experimental apparatus used to collect data in Experimental Example 2.

FIG. 18 shows four consecutive cycles of TCA heating from 25 °C to 100 °C after not being used overnight; the red and blue represent the heating and cooling portions of the cycle, respectively; the heating curve of the first repetition is significantly different from the rest of the trajectories.

FIG. 19 shows the means and standard deviations for the data from Experimental Example 2 plotted with respect to increasing cross-sectional area (A, C, E) and height and width (B, D, F); in (A), (C), and (E), statistically significant differences with the 10×8 pouch are marked by an * for p<0.05 or ** for p<0.001.

FIG. 20 shows the means and standard deviations for the data from Experimental Example 3 plotted for (A) cooling time, (B) heating time, (C) stroke, (D) and maximum hysteresis as a percent of stroke; the number adjacent to the point marks which case it is and if there is a statistically significant difference with Case 1 (channel, Active Cooling), it is marked by ** for p<0.001.

FIG. 21 shows the distribution of temperatures at which the maximum hysteresis occurred in Experimental Example 3.

FIG. 22 shows a schematic of Murata performance of their Piezo Micro Blowers product line for selection of a piezo blower in Experimental Example 5.

FIG. 23 shows impact of voltage on flow rate vs pressure curves for the piezo blower.

FIG. 24 shows an example of a square wave for driving the piezo blower.

FIG. 25 shows a circuit diagram of a piezo driver printed circuit board which includes high side switch and status LED.

FIG. 26 shows a circuit diagram for a testing apparatus for testing performance of a piezo blower cooling of a TCA in a flexible channel.

FIG. 27 shows elevation top, bottom, and side views of a piezo blower.

FIG. 28 shows a partial pipe design forming a part of the flexible channel in Experimental Example 6.

FIG. 29 shows a partial pipe incorporating an integrated docking/mounting interface for attaching the piezo blower. FIG. 29A shows a perspective interior view, while FIG. 29B shows a perspective exterior view.

FIG. 30 shows a partial pipe with piezo blower mounted and TCA installed, but without a fabric piece closing the longitudinal slot of the partial pipe.

FIG. 31 shows an elevation view from the fabric piece side of the flexible channel.

FIG. 32 shows a cross-section view along line A-A shown in FIG. 31.

FIG. 33 shows an elevation view from the partial pipe piece side of the flexible channel.

FIG. 34 shows a cross-section view along line B-B shown in FIG. 33.

FIG. 35 shows a schematic of a plurality of partial pipe pieces 3D printed on a fabric and configured as a forearm brace assembly.

FIG. 36 shows a circuit diagram of electronic components configured to drive and control TCAs and piezo blowers in the forearm brace assembly.

FIG. 37 shows an interior view of a constructed forearm brace assembly.

FIG. 38 shows an exterior view of the constructed forearm brace assembly.

FIG. 39 shows the constructed forearm brace assembly strapped to a subject's forearm in an operational position.

FIG. 40 shows a simplified thermal model of the TCA body consists of the lumped thermal capacitance, Cth, the total thermal resistance, Rtot, the temperature of the TCA body, T_{TCA}, the ambient temperature, T∞, and the total heat entering and exiting the system, qin and qout, respectively.

FIG. 41 shows a thermal resistance circuit during the cooling phase, where the thermal resistance of fabrics can be calculated using a lumped model wherein the yarns, interlacements, and air pores in a fabric can be treated as a system of resistances.

FIG. 42 shows a cross section of ½ twill fabric, where a presents the major axis of the ellipse formed by the yarns (m); b is the major axis of the ellipse formed by the yarns (m), back scatter fraction; l′ is the modular length of warp/weft in the float region (m); l″ is the modular length of warp/weft in the intersection region (m); p′ is spacing between two warps and wefts in the float region (m); p″ is spacing between two warps/wefts in the intersection region (m); and θ is the angle of intersection of warp and weft (rad) [4].

FIG. 43 shows a schematic of total resistance due to conduction as a system of resistances through the fabric [4].

FIG. 44 shows an electrical network analogy for radiation heat flow through air pore [4].

FIG. 45 shows a block diagram of an algorithm to monitor and control heating and cooling of a TCA driven within the cooling system.

### DETAILED DESCRIPTION OF PREFERRED EMBODIMENTS

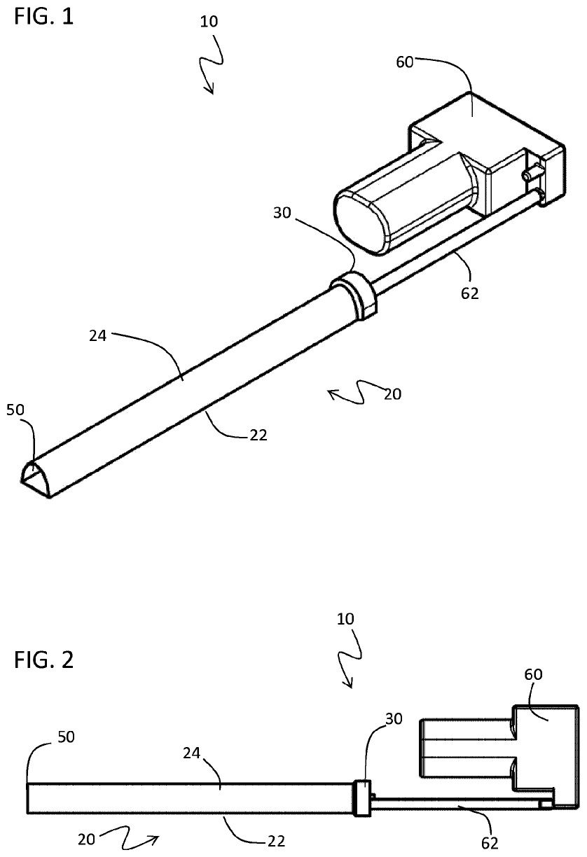

Referring to the drawings, an example of a cooling system 10 is shown in FIGS. 1 to 5. The cooling system 10 can be used to cool thermally activated artificial muscle fibres.

The cooling system 10 comprises a flexible channel 20 of tubular shape defining an interior lumen bound by a first end and a second end. The interior lumen is open from the first end to the second end to permit air flow to communicate from the first end to the second end.

The tubular shape of the flexible channel may be formed with a flattened side 22 that extends along its axial length. In the drawings, the tubular shape of the flexible channel is shown as a half pipe 24 that is closed along its axial length by the flattened side 22, such that the radial cross-sectional shape presents as semi-circular or semi-elliptical at any point along the axial length of the flexible channel. The flexible channel 20 has a similar radial cross-sectional shape along its axial length such that cross-sectional shapes at various points along the length of the lumen are similar to cross-sectional shapes at the first end and the second end. However, variation of radial cross-sectional shape along the axial length of the flexible channel 20 may be accommodated and in certain examples may confer a benefit. Cross-sectional shapes other than semi-circular or semi-elliptical, for example a square cross-sectional shape characterizing a rectangular cylinder tubular shape of a flexible channel, may be accommodated and in certain examples may confer a benefit. Typically, the cross-sectional shape will include at least one flattened side.

An inlet interface 30 is attached to the first end of the flexible channel. The inlet interface 30 is a plate or cap structure that has a first side facing an exterior of the flexible channel 20 and a second side facing the interior lumen of the flexible channel, the inlet interface 30 providing one or more ports for communicative access between an exterior of the flexible channel 20 and its interior lumen. The one or more ports are formed as through-holes or bores within the inlet interface 30 that may be bolstered by cylindrical projections extending from the through-hole or bore. A first port 32 provides an inlet for air flow. A second port 34 provides an attachment point for an artificial muscle fibre and access for electrical leads to connect to the artificial muscle fibre. A third port 36 and a fourth port 38 provide access for inserting temperature sensor leads into the interior lumen. The inlet interface 30 is shown as a two-piece modular structure with a central piece 40 mating with a circumferential piece 42. The central piece houses the one or more ports (for example, first port 32, second port 34, third port 36 or fourth port 38), while the circumferential piece forms a closed attachment with the first end of the flexible channel. The central piece 40 can be mated with the circumferential piece 42 using any convenient fastening, latching, or locking mechanism. An advantage of the two-piece modular structure is that size and port configuration of the central piece can be standardized while variation of the central piece size and shape can accommodate corresponding variation in cross-sectional size and shape of the first end of the flexible channel 20. However, a single integrated structure of the inlet interface is readily accommodated, as are variations of modular structures such as a three-piece modular structure.

While the first end of the flexible channel is capped by the inlet interface 30, the second end of the flexible channel forms opening 50 that provides an outlet to exhaust air flow and an outlet for the artificial muscle or a cable or wire connected to the artificial muscle to pass through to connect with a targeted load, such as a hand, a finger, or any other application known in the field of soft robotics.

An air flow device 60 generates air flow and air pressure that communicates to the interior lumen of the flexible channel through tubing 62. A first open end of tubing 62 is connected to an outlet of the air flow device 60 and a second open end of tubing 62 is connected to the first port 32 disposed in the inlet interface. Therefore the air flow path initiated within the air flow device 60 sequentially flows through tubing 62 and then first port 32 into the interior lumen of the flexible channel 20 and is then exhausted at the opening 50 at the second end of the flexible channel 20.

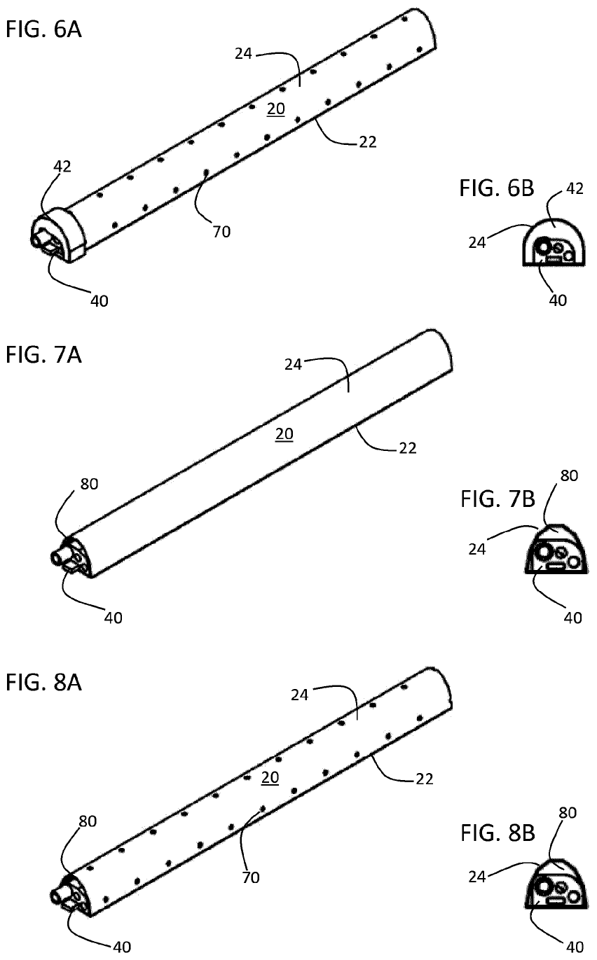

FIGS. 6 to 8 show examples of variation of the flexible channel structure and inlet interface structures. FIGS. 6A and 6B show an example of a flexible channel 20 and inlet interface 30 that is the same as the example shown in FIGS. 1 to 5, except that the half pipe portion 24 of the flexible channel 20 is perforated to form a plurality of apertures 70 to enhance air exhaust or air convection communication with the interior lumen.

FIGS. 7A and 7B show an example of a flexible channel 20 and inlet interface 30 that is the same as the example shown in FIGS. 1 to 5, except that the inlet interface does not include the circumferential piece 42 and instead the central piece 40 attaches to the first end of the flexible channel 20 forming a gap 80 that may benefit air entrainment.

FIGS. 8A and 8B show an example of a flexible channel 20 and inlet interface 30 that is the same as the example shown in FIGS. 1 to 5, except for including both of the modifications shown in FIGS. 6 and 7: specifically, including a perforated flexible channel providing a plurality of apertures 70 along its axial length and attachment of the central piece of the 40 to the first end of the flexible channel 20 to form a gap 80.

The cooling system and associated devices and methods for cooling artificial muscles have been validated by experimental testing. Experimental testing results demonstrate the ability of the cooling system, and associated devices and methods to cool thermally activated artificial muscle fibres. The following experimental examples are for illustration purposes only and are not intended to be a limiting description.

### Experimental Exemplification: Experimental Example 1

Musculoskeletal disorders are the leading cause of disability in Canada, and each year over 50,000 Canadians must take time off work to recover from upper extremity workplace injuries [1][2].

Robotic devices assist with physiotherapy, support activities of daily living, and suppress tremor in Parkinson's Disease [3][4]. Robotic rehabilitation was demonstrated to be effective for stroke rehabilitation and patient reported outcomes state that robotic therapy is more encouraging and engaging [5][6]. This type of therapy has several advantages, including real-time feedback, quantitative measurements, and progress tracking [7].

The high cost of robotic systems makes it challenging to provide robotic therapy at a large scale [6]. Additionally, most of the developed systems are large, bulky, and stationary, which is a result of using electric motors as the primary actuator [3][4]. Thus, there is a need for less expensive, lighter, and slimmer actuators for wearable robotic devices.

A novel artificial muscle, called a Twisted Coiled Actuator (TCA), was proposed by Haines et al. [8]. TCAs are created by super-coiling nylon threads. When thermally activated, the expansion in the radial direction allows the actuator to contract up to 21% in length and carry loads up to 80 MPa [8]. An accepted fabrication method involves using silver-coated nylon 6,6 to allow for electrical heating and plying two strands together to create a double helix [9][10]. TCAs are a promising actuator for wearable robotic devices, as they are lightweight, inexpensive, and biomimetic.

A limitation for employing TCAs in wearable robotic devices is that the bandwidth obtained with passive cooling (0.03 Hz) is too slow to support rehabilitation exercises or voluntary motion [10]. Slow rehabilitation motions can occur at as low as 0.05 Hz, while slow voluntary motion is at around 1 Hz, and small active motions can be at or above 5 Hz [11][12][13]; thus obtaining cooling times to support these frequencies is necessary.

Kianzad tested the performance of TCAs in four environments: forced air, still air, hydrogel, and water [14]. It was found that the water and hydrogel environments offered the fastest cooling times, but the hydrogel had a limited life time (up to 30 actuation cycles) and the water decreased the efficiency of the TCA during heating.

It has been shown that enclosing the TCA in a rigid plastic tube to direct the air flow is an effective method of cooling the TCAs, and displacements of up to 7% at 1 Hz were obtained with an input pressure of 50 psi [15]. However, a rigid plastic tube is difficult to embed in soft wearable robotic systems.

When designing for wearable robotic systems, there are several factors that must be considered. The design should be lightweight, durable, safe for the user, and comfortable.

The novel cooling system involves a flexible fabric channel to guide the air over the TCA and a miniature pump to circulate the air. A fabric channel can move with the user and it can easily be sewn onto underlying garments to create wearable devices and fix the TCA in place. The fabric channels can be made of any length, but they should be approximately the same length as the TCA at its fully extended position to ensure that the entire TCA is covered.

Air was chosen for the forced convection medium, as when compared to a liquid, it involves less hardware, leaks are less disruptive, and it is lighter. The material for the channel was selected to be air impermeable, lightweight, flexible, easy to sew, and withstand the operating temperatures of the TCA (up to 130-C). Thus, tightly woven nylon pack cloth with an ether-based thermoplastic polyurethane film was selected.

Through trial and error, it was found that a semi-circular shape for the cross section of the channel returned to its original shape best when deformed, and was the easiest to fabricate. The outside of the channel can be surrounded with insulation to protect the user from the temperatures that the TCA reaches.

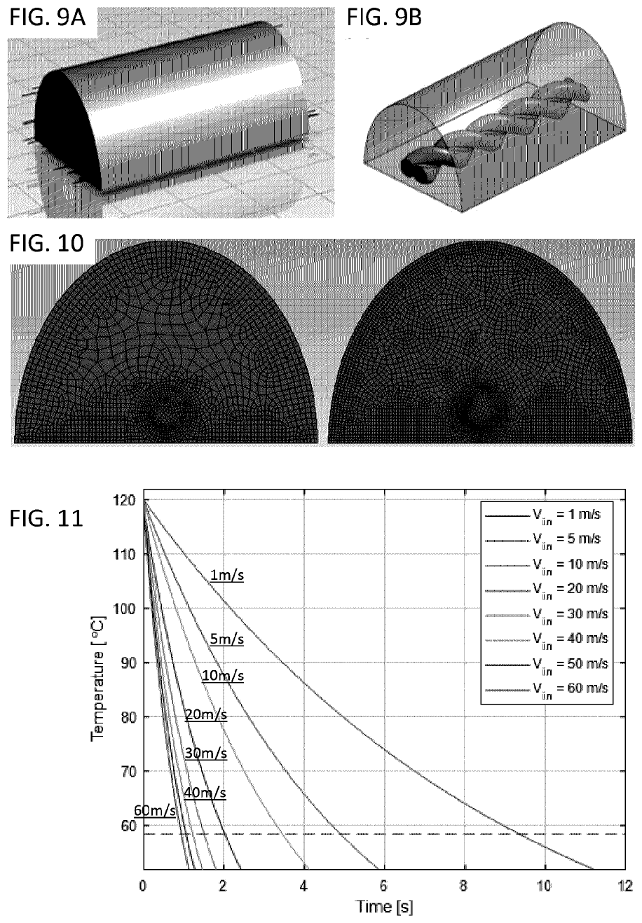

To assess if the channel design will allow the TCA to cool rapidly enough to support either rehabilitation or voluntary motion, it was modeled in ANSYS Fluent (FIG. 9A) and the relationship between the cooling time and input air velocity was determined.

Experimental Example 1: Assumptions and Simplifications. First, the size of the channel was set to 6 mm in width, 4 mm in height, and 10 mm in length. The height and width parameters were determined by the size of the TCA crimp and pump outlet, whereas the length was reduced to a tenth of the TCA length to decrease computational time.

The shape of a TCA is a complex double helix. To reduce the complexity of the geometry, the TCA was simplified to a cylindrical pipe. The diameter of the pipe was calculated by matching the volume of the pipe to the volume of the TCA. The volume of the TCA was obtained through a CAD model (FIG. 9B.) where the diameter of each TCA strand was 0.8 mm and the pitch was 4 mm to match the physical TCA. This results in a volume of 10.3 mm³ and a model TCA diameter of 1.15 mm.

It was assumed that the primary method of heat transfer is the forced convection through the channel and that radiation is negligible. Since the exterior of the channel would be insulated to protect the user, it was assumed that there is no heat transfer through the walls of the channel. It was also assumed that the conduction through the channel is negligible, as the material is only 0.3 mm thick.

To determine if the flow in the channel is laminar or turbulent, the Reynolds number was estimated. The Reynolds number can be computed according to (Eq. 1), where ρ is the density of the fluid, ν is the velocity, D_{H} is the hydraulic diameter, and p is the dynamic fluid viscosity. For air at 22.5 °C, ρ=1.194 kg/m³ and μ=18.6×10⁻⁶ Pas. From the CAD model, the cross sectional area for the air flow is 17.8 mm² and the wetted perimeter is 20.65 mm, resulting in a hydraulic diameter of 3.45 mm, according to (Eq. 2). Any input velocity with a Reynolds number below 2300 was simulated with the laminar model, and those with Reynolds numbers above 2300 used a turbulence model.

$$Re = \frac{{pvD}_{H}}{μ} \qquad ( 1 )$$

$${D}_{H} = \frac{4 * cross sectional area}{wetted perimeter} \qquad ( 2 )$$

ANSYS Fluent uses turbulence models in the Reynolds Averaging Navier Stokes family, which means that only the mean flow quantities (e.g., velocity) are solved, as opposed to solving for the flow eddies. The impact of the eddies is accounted for by estimating the energy loss due to the turbulence in the flow. For this situation, the SST k-omega turbulence model was employed, as it can be used when the turbulent flow is not fully developed, as is the case with low Reynolds numbers [16]. This model adds two additional transport equations to find the turbulent kinetic energy, k, and the specific turbulent dissipation rate, o, to estimate the impact of the turbulence on the flow [17].

The input velocities selected were 1 m/s, 5 m/s, 10 m/s, 20 m/s, 30 m/s, 40 m/s, 50 m/s, and 60 m/s. The mach number can be found by dividing the input velocity by the speed of sound. The largest mach number, for the input velocity of 60 m/s, is 0.175. Since the mach number is below 0.3, the flow can be assumed to be incompressible [18].

To further simplify the model, both the motion of the TCA in the channel and gravity will be neglected. The material properties of the TCA were assumed to be the same as those reported by Sun et al. [19] and are as follows: density 1300 kg/m³; specific heat capacitance 1267 J/kgK; thermal conductivity 4.6 W/mK.

Finally, since the heating and cooling curves for TCAs have been modeled as linear first order systems, it was assumed that the simulation results would also follow a first order system [20][21]. This allows the cooling time to be approximated with the time constant, so the simulations were run until the temperature of the TCA reached below 58.4 °C (36.8% of the steady state temperature).

### Experimental Example 1: Mathematical Models

To solve this simulation, Fluent will have to solve the conservation of energy (Eq. 3) to find the temperatures of the air and TCA, and the conservation of mass (Eq. 4) and momentum (Eq. 5) equations to find the flow velocities and pressure [22][23][24]. For the laminar flows, no additional models or equations are required, however for the turbulent flows, two additional transport equations, (Eq. 6) and (Eq. 7), are required to find the turbulent kinetic energy, k, and the specific turbulent dissipation rate, ω [17].

In these equations, t is time, ρ is density, V is the fluid velocity, P is the pressure, k_{eff} is the effective thermal conductivity, T is temperature, h is the enthalpy, J is the diffusion flux, r is the stress-strain tensor, and S is the heat source. E is defined as E=hP/ρ+ν²/2, where v is the velocity magnitude. For (Eq. 6) and (Eq. 7), x is the position, i and j represent 1, 2, and 3 for the x, y, and z directions, and u is the magnitude of the i component of the velocity. Additionally, Gₖ and G_{ω} are the generation of k and ω, Γₖ and Γ_{ω} are the effective diffusivity of k and ω, and D_{ω} is the cross-diffusion term.

$$\frac{δ}{δ t} ( ρ E ) + ∇ \cdot ( \vec{V} ( ρ E + P ) ) = ∇ \cdot ( {k}_{eff} ∇ T - hJ + ( \overline{\overline{τ}} \cdot \vec{V} ) ) + S \qquad ( 3 )$$

$$\frac{δρ}{δ t} + ∇ \cdot ρ \vec{V} = 0 \qquad ( 4 )$$

$$\frac{d}{dt} ( ρ \vec{V} ) + ∇ \cdot ( ρ \vec{V} \vec{V} ) = - ∇ P + ∇ \cdot \overline{\overline{τ}} \qquad ( 5 )$$

$$\frac{\partial }{\partial t} ( ρ k ) + \frac{\partial }{\partial {x}_{i}} ( ρ {ku}_{i} ) = \frac{\partial }{\partial {x}_{j}} ( {Γ}_{k} \frac{\partial k}{\partial {x}_{j}} ) + {G}_{k} - {Y}_{k} \qquad ( 6 )$$

$$\frac{\partial }{\partial t} ( ρω ) + \frac{\partial }{\partial {x}_{i}} ( ρω {u}_{i} ) = \frac{\partial }{\partial {x}_{j}} ( {Γ}_{ω} \frac{\partial ω}{\partial {x}_{j}} ) + {G}_{ω} - {Y}_{ω} + {D}_{ω} \qquad ( 7 )$$

### Experimental Example 1: Boundary Conditions and Initial Conditions

To solve the differential equations, boundary conditions and initial conditions must be set. For the walls of the channel, the inlet was set to a velocity inlet, the outlet was set to a pressure outlet with zero gauge pressure, and the walls of the channel were set to stationary walls with no slip conditions and zero heat flux. The outer surface of the TCA was set to a coupled thermal condition, to allow heat transfer between the TCA and the air, with an additional no slip condition. The faces of the TCA at the inlet and outlet were set with zero heat flux, which assumes that the section of the TCA that is being simulated is not influenced by the material on either side of it.

The system was initialized to 120 °C to mimic the end of a TCA heating cycle. The input air was set to 22.5 °C as room temperature air will be blown through the channel.

### Experimental Example 1: Boundary Conditions and Initial Conditions

When setting up the simulations, several settings must be determined and the model must be divided up into many small segments, called elements.

The simulation determines the velocity, pressure, and temperature of the flow by solving (Eqs. 3-7) for each element in the model. The inaccuracies in the solution are assessed using residuals, which are the differences between the left and right hand sides of the conservation equations summed over all of the elements [25]. Generally, the smaller the residuals are, the more physically accurate the solution is. The software repeatedly solves (iterates) through the conservation and transport equations to increase the accuracy of the solution by re-calculating the variables in the equations based on values from the previous iteration.

Relaxation factors can be set to improve>the stability of the solution by decreasing the amount of change that occurs between iterations. For this model, relaxation factors were set to 0.75 to ensure that the solution converged, and in each time step iterations were performed until all residuals were below 1×10⁵, or until 20 iterations were completed. The mass flow rates at the inlet and outlet were observed to ensure that the solution was physically meaningful, and the temperature of the TCA was monitored by recording the average temperature over the outer surface of the TCA.

To solve the conservation equations, (Eqs. 3-5), the software can use either a segregated or a coupled approach for the pressure-velocity scheme. For the segregated scheme, the flow velocities and pressure are solved by iterating with (Eq. 4) and (Eq. 5), then the result is applied to (Eq. 3) to solve for the temperatures. Alternatively, the coupled scheme solves all three equations each iteration. The coupled scheme was used to improve the solution convergence time [26].

Spacial discretization schemes have to be selected to tell the software how to solve for the values of variables (pressure, momentum, energy, etc.) at the surfaces of the model elements. Second order schemes were selected for all variables to increase solution accuracy.

Finally, since the flow is assumed to be incompressible, the pressure based solver was selected, as it is traditionally better for low-speed incompressible flows [27]. This assumes that the pressure of the fluid is a weak function of density and temperature, which occurs with low mach flows.

### Experimental Example 1: Grid Independence Test

Meshing is the process by which the model is split into the small elements. To ensure the results do not depend on the mesh that is used, a grid independence test must be conducted. Two meshes were created and can be seen in FIG. 10. The parameters used to create them and the resulting properties are summarized in Table 1. The simulations were run for 0.25 s with a time step of 1 ms. The maximum percent difference between the surface temperature of the TCA was 0.0042%, indicating the results do not depend on the mesh. Mesh 1 was selected to reduce computational time.

TABLE 1
Parameters used in mesh fabrication and resulting mesh properties.

| Parameter | Mesh 1 | Mesh 2 |
|---|---|---|
| Divisions Along Upper Wall | 120 | 200 |
| Divisions Along Bottom Wall | 100 | 120 |
| Divisions Around the TCA | 70 | 90 |
| Maximum Element Size [m] | 6 × 10⁻⁴ | 1 × 10⁻⁴ |
| Minimum Orthogonal Quality | 2.48 × 10⁻³ | 9.47 × 10⁻² |
| Maximum Aspect Ratio | 2660 | 29.40 |
| Minimum Element Volume [m³] | 3.25 × 10⁻¹⁴ | 5.41 × 10⁻¹⁴ |
| Maximum Element Volume [m³] | 2.56 × 10⁻¹¹ | 3.46 × 10⁻¹² |
| Number of Elements | 87,150 | 221,850 |
| Number of Nodes | 95,674 | 236,949 |

Experimental Example 1: Time Step Independence Test. Similarly, a time step independence test was conducted. Simulations were run for 0.25 s with time steps of 1 ms and 5 ms. Since the maximum percent difference in TCA surface temperature was 0.025%, the results are not dependent on the time step. A time step of 5 ms was selected to reduce computational time.

Experimental Example 1: Results. FIG. 11 displays the TCA temperature vs. time curves for all input velocities and the dashed horizontal line marks 58.4 °C, where the time constant was measured. As expected, the time constant decreases as the input velocity increases, as shown in FIG. 12. The line of best fit was found to be τ=11.02 Vᵢₙ ^{-0.58} with an R² value of 0.98, where τ is the cooling time constant and Vᵢₙ is the input air velocity.

The estimated input velocities for rehabilitation and voluntary motion can be found by using the line of best fit, as seen in Table 2. To obtain the required time constant from the frequency, it was assumed that half of the period would be allocated to heating the TCA and half of the period would be allocated to cooling the TCA. Then, the required time constant is a fifth of the cooling time, as it takes approximately five time constants for a system to reach steady state. To summarize, τ_{reg}=0.1/f, where f is the desired frequency. Next, the estimated flow rate can be computed from the estimated input velocity using the following relationship: Q=VA, where V is the input velocity and A is the cross sectional area of the channel obtained from the CAD model (17.8×10⁶ m²)

TABLE 2
Estimation of input air velocity to obtain the required actuation frequencies.

| Frequency | Required τ | Estimated Vᵢₙ | Estimated Flow Rate |
|---|---|---|---|
| [Hz] | [s] | [m/s] | [m³/min] |
| 0.05 | 2 | 18.2 | 0.019 |
| 1 | 0.1 | 3,182.4 | 3.403 |
| 5 | 0.02 | 50,311.7 | 53.793 |

When selecting a pump for a wearable robotic device, it is important to minimize the amount the pump would protrude (its height), the overall size of the pump, and its mass. Some miniature air pumps that would be suitable for use in wearable devices are listed in Table 3. It can be seen that these pumps are incapable of providing the flow rates required to support rehabilitation or voluntary motion.

TABLE 3
Miniature air pump specifications (BP = Bianca Pumps, SP = Schwarzer Precision).

| Company/ | Air Flow | Height | Length | Width | Mass |
|---|---|---|---|---|---|
| Part Number | [m³/min] | [mm] | [mm] | [mm] | [g] |
| BP | 0.0004 | 8 | 32 | 18 | 8 |
| SX-1 | | | | | |
| SP | 0.0015 | 16 | 56 | 36 | 38.5 |
| 16A RO-DV | | | | | |
| SP | 0.0025 | 18 | 62 | 32 | 44 |
| 18A RO-D | | | | | |
| BP | 0.0035 | 27 | 58 | 27 | 68 |
| SX-4 | | | | | |
| BP | 0.0080 | 31 | 80 | 78 | 225 |
| GX-3-D | | | | | |
| BP | 0.0100 | 40 | 86 | 65 | 295 |
| SX-7 | | | | | |
| BP | 0.0150 | 60 | 112 | 60 | 295 |
| SX-8 | | | | | |

While the predicted input air velocities and flow rates required to support voluntary motion are impractical for a wearable device, the flow rate for the largest air pump (BP SX-8) is close to that predicted to support rehabilitation exercises. Previous work has shown that increasing the size of the tube the TCA is in resulted in lower cooling times, thus increasing the size of the channel may allow the fabric channels and miniature air pumps to achieve frequencies required for rehabilitation [28].

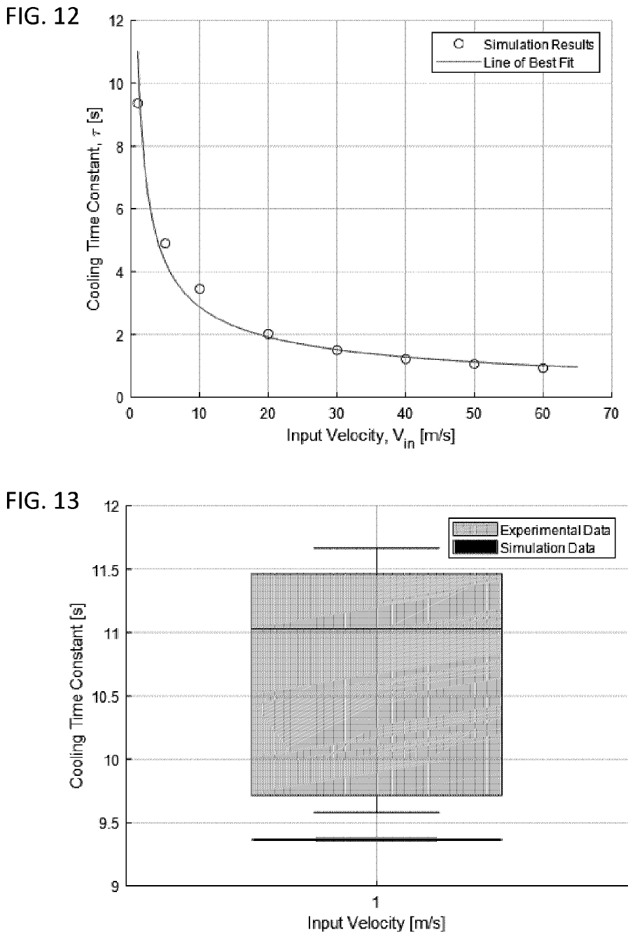

To validate the simulation data, a preliminary experiment was performed. Three channels of 6 mm width and 4 mm height were fabricated with nylon pack cloth from Trident Textiles Corp. and were insulated with 8 mm of foil-backed insulation from InsulTech. A TCA was made with silver plated nylon 6,6 thread (Shieldex™, Part #: 260151023534) and its temperature was monitored using the temperature sensor design proposed by Edmonds [10]. The TCA was loaded with 100 g and was heated to 120 °C five times in each channel. It was cooled with the Schwarzer Precision 16A RO-DV pump running at 100% duty cycle and the room temperature was 22.7 °C. The air flow was measured with a Renesas FS2012-1020-NG air flow sensor to be between 0.0011 m³/min to 0.0012 m³/min, which equates to between 1.0 m/s and 1.1 m/s when divided by the cross-sectional area of the channel (17.8×10⁻⁶ m²). The time constants for the experimental results ranged between 9.58 s to 11.67 s with an average of 10.8 s. The simulation predicted a time constant of 9.37 s for an input of 1 m/s, resulting in a percent difference of 13.2% when compared to the mean experimental value. The comparison between the simulation and experimental data is shown in FIG. 13.

The variation in the experimental results likely comes from the positioning of the TCA in the channel and differences in the channels due to the fabrication method. The main sources of error between the simulation and experimental results are likely the differences in the geometry of the TCA and the neglect of the motion and deformation of the TCA in the model. Other sources of error and variation in the results would include the positioning of the TCA in the channel (the model assumes it is perfectly centered), the impact of the TCA on either side of the simulated portion, and slight differences in material properties and room temperature.

### Experimental Example 1: Reference List

[1]J. Kopex, J. Cibere, E. Sayre, L. Li, D. Lacaille, and J. Esdaile, “Descriptive epidemiology of musculoskeletal disorders in canada: Data from the global burden of disease study,” Osteoarthritis and Cartilage, vol. 27, p. S259, 2019.
[2] Association of Workers' Compensation Boards of Canada, “National work injury, disease and fatality statistics,” 2018, accessed 28 Jul. 2020.[Online]. Available: https://awcbc.org/wp-content/uploads/2020/05/National-Work-Injury-Disease-and-Fatality-Statistics-2016-2018.pdf
[3] P. Maciejasz, J. Eschweiler, K. Gerlach-Hahn, A. Jansen-Troy, and S. Leonhardt, “A survey on robotic devices for upper limb rehabilitation,” Journal of Neuroengineering and Rehabilitation, vol. 11, no. 3, 2014.
[4]T. Desplenter, Y. Zhou, B. P. Edmonds, M. Lidka, A. Goldman, and A. L. Trejos, “Rehabilitative and assistive wearable mechatronic upper-limb devices: A review,” Journal of Rehabilitation and Assistive Technologies Engineering, vol. 7, 2020.
[5]P. Lum, C. Burgar, P. Shor, M. Majmundar, and M. V. der Loos, “Robot-assisted movement training compared with conventional therapy techniques for the rehabilitation of upper-limb motor function after stroke,” Archives of Physical Medicine and Rehabilitation, vol. 83, no. 7, pp. 952-959, 2002.
[6]M. Gandolla, A. Antonietti, V. Longatelli, and A. Pedrocchi, “The effectiveness of wearable upper limb assistive devices in degenerative neuromuscular diseases: A systematic review and meta-analysis,” Frontiers in Bioengineering and Biotechnology, vol. 7, no. 450, 2020.
[7]J. Brackenridge, L. Bradnam, S. Lennon, J. Costi, and D. Hobbs, “A review of rehabilitation devices to promote upper limb function following stroke,” Neuroscience and Biomedical Engineering, vol. 4, no. 1, pp. 25-42, 2016.
[8]C. Haines, M. Lima, N. Li, G. Spinks, J. Foroughi, J. Madden, S. Kim, S. Fang, M. Andrade, F. Goktepe, O. Goktepe, S. Mirvakili, S. Naficy, X. Lepro, J. Oh, M. Kozlov, S. J. Kim, X. Xu, B. Swedlove, and R. Baughman, “Artificial muscles from fishing line and sewing thread,” Science (New York, N.Y.), vol. 343, pp. 868-72, 2014.
[9]K. H. Cho, M.-G. Song, H. Jung, S. Y. Yang, H. Moon, J. C. Koo, J. do Nam, and H. R. Choi, “Fabrication and modeling of temperature-controllable artificial muscle actuator,” in 2016 6th IEEE International Conference on Biomedical Robotics and Biomechatronics (BioRob), University Town, Singapore, Jun. 26-29, 2016, pp. 94-98.
[10]B. P. Edmonds, “Feasibility of twisted coiled polymer actuators for use in upper limb wearable rehabilitation devices,” Ph.D. dissertation, Western University, 2020.
[11] M. T. Moffroid and R. H. Whipple, “Specificity of speed of exercise,” Physical Therapy, vol. 50, no. 12, pp. 1692-1700, 1970.
[12] K. A. Mann, F. Werner, and A.K. Palmer, “Frequency spectrum analysis of wrist motion for activities of daily living,” Journal Orthopaedic Research, vol. 7:2, pp. 304-306, 1989.
[13] M. Tanimoto and N. Ishii, “Effects of low-intensity resistance exercise with slow movement and tonic force generation on muscular function in young men,” Journal of Applied Physiology, vol. 100, no. 4, pp. 1150-1157, 2006.
[14] S. Kianzad, “A treatise on highly twisted artificial muscle: Thermally driven shape memory alloy and coiled nylon actuators,” Master's thesis, University of British Columbia, 2015. [Online]. Available: https://open.library.ubc.ca/collections/ubctheses/24/items/1.0166707
[15] B. P. Edmonds and A. L. Trejos, “Frequency response analysis of actively cooled nylon twisted coiled actuators for use in wrist rehabilitation devices,” in 8th IEEE RAS/EMBS International Conference for Biomedical Robotics and Biomechatronics (BioRob), New York, USA, November 29-Dec. 1, 2020, pp. 434-439.
[16] SIMSCALE, “K-omega and k-omega sst,” 2021, last accessed 12 Dec. 2021. [Online]. Available: https://www.simscale.com/docs/simulation-setup/global-settings/k-omega-sst/
[17] ANSYS, “4.5.2 shear-stress transport (sst) k-ω model,” 2009, last accessed 12 Dec. 2021. [Online]. Available: https://www.afs.enea.it/project/neptunius/docs/fluent/html/th/node67.htm
[18] F. M. White, Fluid Mechanics, 7th ed. New York: McGraw Hill, 2011.
[19] J. Sun, B. Paulowski, and J. Zhao, “Embedded and controllable shape morphing with twisted-and-coiled actuators,” in International Conference on Intelligent Robots and Systems (IROS), Madrid, Spain, Oct. 1-5, 2018, pp. 5912-5917.
[20] B. P. Edmonds and A. L. Trejos, “Computational fluid dynamic study of a soft actuator for use in wearable mechatronic devices,” in 7th IEEE International Conference on Biomedical Robotics and Biomechatronics, The Netherlands, Aug. 26-29, 2018, pp. 1333-1338.
[21] M. C. Yip and G. Niemeyer, “High-performance robotic muscles from conductive nylon sewing thread,” in 2015 IEEE International Conference on Robotics and Automation (ICRA), Seattle, USA, May 25-30, 2015, pp. 2313-2318.
[22] ANSYS, “5.2.1 heat transfer theory,” 2009, last accessed 20 Jan. 2022. [Online]. Available: https://www.afs.enea.it/project/neptunius/docs/fluent/html/th/node107.htm
[23] ANSYS, “1.2 continuity and momentum equations,” 2009, last accessed 20 Jan. 2022. [Online]. Available: https://www.afs.enea.it/project/neptunius/docs/fluent/html/th/nodel.htm
[24] ANSYS, “16.5.3 conservation equations,” 2009, last accessed 20 Jan. 2022. [Online]. Available: https://www.afs.enea.it/project/neptunius/docs/fluent/html/th/node322.htm
[25] ANSYS, “26.13.1 monitoring residuals,” 2009, last accessed 20 Jan. 2022. [Online]. Available: https://www.afs.enea.it/project/neptunius/docs/fluent/html/ug/node812.htm
[26] ANSYS, “18.4.3 pressure-velocity coupling,” 2009, last accessed 22 Nov. 2021. [Online]. Available: https://www.afs.enea.it/project/neptunius/docs/fluent/html/th/node373.htm
[27] ANSYS, “26.1 overview of using the solver,” 2009, last accessed 22 Nov. 2021. [Online]. Available: https://www.afs.enea.it/project/neptunius/docs/fluent/html/ug/node776.htm
[28] B. P. Edmonds and A. L. Trejos, “Design of an active cooling system for thermally activated soft actuators,” in 16th IEEE International Conference on Rehabilitation Robotics (ICORR), Toronto, Canada, Jun. 24-28, 2019, pp. 368-373.

### Experimental Exemplification: Experimental Example 2

Robotic therapy can provide equivalent benefits to conventional physiotherapy, and limb functions improve when robotic therapy is completed in addition to conventional therapy, especially with chronic stroke patients (4, 5). Robotic therapy has many advantages such as progress tracking, real-time feedback, and reducing therapist workloads.

These robotic devices are not common due to their high cost and limited portability, which stems in part, from using electric motors as the primary actuator (6, 7, 8). One method to reduce the cost and increase the portability of wearable robotic devices is to use alternative actuators, such as artificial muscles. Artificial muscles have additional advantages of being biomimetic and compliant, which reduces the chance of injury to the user. There are several types of artificial muscles available, such as shape memory alloys (SMAs), pneumatic artificial muscles (PAMs), and twisted coiled actuators (TCAs).

SMAs are thermal actuators that alternate between two states upon heating and cooling. They can be formed into artificial muscles with low voltage requirements and high power-to-mass ratios. Unfortunately, they have large amounts of hysteresis which makes them difficult to control, and their cycle life decreases as the amount they are strained increases (9).

PAMs are fabricated by covering an internal air bladder in a woven mesh such that when the air bladder is inflated, the system contracts (10). PAMs are advantageous as they are naturally compliant and they have a high power-to-weight ratio when the air compressor is ignored. Their main disadvantage is that they require an air compressor to actuate, which is loud, heavy, and frequently tethers the user to one spot. Recently, these muscles have been embedded into fabric to create a glove to help finger flexion (11, 12).

TCAs are a promising actuator for wearable robotic devices due to their inherent compliance, low profile, easy and inexpensive fabrication method, and linear actuation (13). These artificial muscles are created by super-coiling silver-coated nylon thread, and they can carry loads up to 80 MPa. They will contract up to 21% when electrically heated and extend upon cooling. Unfortunately, their low bandwidth with passive cooling (0.03 Hz) limits their effectiveness in devices designed for rehabilitation purposes (14). To increase the potential for TCAs to be used in wearable robotic devices, their cooling time needs to be decreased.

### Experimental Example 2: Channel Design

TCA is used as an actuator and a cooling apparatus is designed to increase the cooling rate of the TCA, and to facilitate incorporation of TCAs into soft wearable robotic devices. Several design attributes were considered during the development of the channel. First, the cooling apparatus had to be portable and help protect the user from the temperatures reached by the TCAs (up to 120 °C). Next, the mass and size of the cooling apparatus needed to be minimized to ensure that the wearable device is as unobtrusive as possible. Ideally, the apparatus will also be durable, flexible, elastic, and breathable, to allow the user to comfortably wear it for extended periods of time. Finally, any negative effects of the cooling apparatus on TCA behavior (e.g., decreased stroke), should be minimized where possible to maintain the capabilities of the TCA.

Considerations for decreasing the cooling time of the TCA included adding a coating to the surface of the TCA to increase its thermal conductivity or changing the environment in which the TCA resides. Modifying the TCA by adding a coating was disregarded as an initial solution, since coatings increase the manufacturing complexity and cost of the TCA, they do not provide a means of integrating the TCA into a wearable system, nor would they help protect the user against the high temperatures reached by TCAs. Thus, the environment of the TCA was changed by enclosing a TCA in a channel and employing forced convection.

Forced convection could be accomplished with a liquid (e.g., water) or a gas (e.g., air). Water and other liquids have a significantly higher thermal conductivity compared to air, which would drastically reduce the cooling time of the TCA. However, liquid coolants have many disadvantages when considering them for a wearable device. They are denser than air and require additional hardware, such as a reservoir and valves, resulting in a significantly heavier and more complex system. Additionally, there is the risk of leaks, which could decrease user comfort, and nylon TCAs will absorb water over time, degrading their performance (14). Finally, the higher thermal conductivity of liquids results in higher power requirements for the heating phase of the TCA (15). Some of these disadvantages could be alleviated by surrounding the TCA in stagnant water, however this was disregarded as a potential solution as the temperature of the water would gradually increase with prolonged use of the TCA, and similar cooling times can be obtained with forced air convection (15). The main disadvantage of forced air convection is that air compressors are noisy, however, the advantages of less mass, hardware, and no degradation of TCA performance allow it to meet the requirements better than a liquid system.

There are three main options to circulate air: fans, air pumps, and air compressors. Air compressors were not selected, as their large size and mass limit their portability. Table 4 displays some commercially available miniature air pumps and fans. Air pumps are capable of producing higher air pressures than fans, however, fans have the advantages of being lighter, smaller, and producing more air flow than the pumps. From the options listed in Table 4, fans have the additional benefit of producing less noise (between 15-36 dB) when compared to the pumps (around 55 dB). For context, the volume of a normal conversation occurs at around 60 dB (19).

While fans would be the optimal solution due to their advantages, testing with preliminary prototypes using a Sunon Fans MF20100V1-1000U-A99 demonstrated that their low pressure capabilities were unable to force air through the devised solution. Therefore, a pump was selected by maximizing the air flow and pressure capabilities while minimizing the height and mass. From this trade off, the Schwarzer Precision SP 16A RO-DV pump was selected, and is the pump used in all of the experiments described in Experimental Example 2 and Experimental Example 3.

TABLE 4
Commercially available miniature air pumps and fans
that meet the 20 mm height constraint.

| | | Maximum | Maximum | | | | |
|---|---|---|---|---|---|---|---|
| | Company/ | Air Flow | Pressure | Height | Length | Width | Mass |
| Fan/Pump | Part | [cm³/min] | [atm] | [mm] | [mm] | [mm] | [g] |
| Pump | Binaca | 400 | 0.39 | 8 | 32 | 18 | 8 |
| | SX-1 | | | | | | |
| | Schwarzer | 650 | 0.49 | 12 | 51 | 27 | 23 |
| | Precision | | | | | | |
| | SP 12 RO | | | | | | |
| | Schwarzer | 1500 | 0.79 | 16 | 56 | 36 | 38.5 |
| | Precision | | | | | | |
| | SP 16A RO-DV | | | | | | |
| | Binaca | 1000 | 0.69 | 17 | 45 | 27 | 32 |
| | CX1 | | | | | | |
| | Schwarzer | 2500 | 0.59 | 18 | 62 | 32 | 44 |
| | Precision | | | | | | |
| | SP 18A RO-D | | | | | | |
| Fan | Sunon Fans | 1170 | 0.00016 | 9 | 9 | 3 | 0.91 |
| | UB393-700TC | | | | | | |
| | Nidec Copal | 11890 | 0.00005 | 16 | 16 | 4.5 | 1.2 |
| | Electronics | | | | | | |
| | F16FB- | | | | | | |
| | 05LLC/E | | | | | | |
| | Delta | 16140 | 0.00098 | 17 | 17 | 5.3 | 1.81 |
| | Electronics | | | | | | |
| | BSB0205HP-00EFG | | | | | | |
| | Sunon Fans | 53800 | 0.00071 | 20 | 20 | 10 | 4.65 |
| | MF20100V1- | | | | | | |
| | 1000U-A99 | | | | | | |

Another consideration in channel design was to devise a method of enclosing the TCA that was flexible, easy to integrate into wearable devices, and could protect the user. It was decided to create a fabric channel, as fabric is flexible and can be sewn onto other materials, including insulation and underlying garments. The fabric for the channel must meet several criteria to ensure the success of the design. It should be flexible, durable, and be able to withstand temperatures above 120 °C. Ideally, the material would be able to slightly stretch and be breathable, to ensure user comfort, and be able to hold a shape without additional supports, to minimize the complexity and cost of fabrication.

Two common durable fabrics are tightly woven nylon and polyester, which are often used in parachutes and windbreakers. While they both have a melting temperature above 220 °C, nylon was selected because nylon threads have a lower coefficient of friction compared to polyester (20). Tightly woven nylon 6 pack cloth with a thickness of 0.3 mm was sourced from Trident Textiles Corp. The material is 100% nylon with a 0.05 mm coating of ether-based thermoplastic polyurethane (ether TPU) on one side. The channels were created with the ether coating on the outside surface as it seemed to have higher friction, and there were concerns about melting the ether TPU. Ester TPU was selected as an alternative material as it has a melting temperature of approximately 145 °C, it can stretch slightly, and it was used in another study to create PAMs embedded in wearable devices (12, 21). Samples of 0.3 mm ester TPU were obtained from Plastic Film Corporation. Preliminary prototypes proved that both materials were easy to sew and were capable of maintaining their cross-sectional shape. To ensure that they could withstand the temperatures reached by TCAs, a TCA was held on the material at approximately 115 °C for 10 minutes. There was no visible deformation to the nylon fabric, however, sections of the ester TPU melted. Thus, the material for the channels was selected to be nylon pack cloth.

After the material was selected, preliminary prototypes were created to determine the cross sectional shape of the channel. The nylon cloth was sewn into four shapes—a circle, a semi-circle/ellipse, a triangle, and a square. The channel must be able to maintain its shape to ensure that there is adequate space for air to flow around the TCA and that no additional friction is caused by contact between the TCA and channel walls. It should also return to shape if deformed to ensure that the performance of the channel does not degrade if the user bumps their limb or folds the fabric. The circle was the easiest channel to manufacture; however, it was easy to flatten and did not return to its shape on its own, which resulted in the TCA being pinched by the fabric on two sides. The triangle was unable to remain open to provide an airway for the TCA. While the square and the semi-circle both had acceptable airways and could quickly return to their shapes when flattened, the semi-circle was significantly simpler to manufacture. For Experimental Example 2 and Experimental Example 3, the channels being designed and tested will be semi-elliptical in shape. In Experimental Example 2 the main design parameters will be the width of the channel (the horizontal diameter of the ellipse) and the height of the channel (the vertical radius of the ellipse).

It is desirable to keep the dimensions of the channel as small as possible to reduce both the protrusion from the limb and the space on the device that would not be breathable, as the selected material is air impermeable. Additionally, if either the height or width are much larger than the other, the ability of the channel to maintain its shape decreases. The minimum height and width were determined by considering the size of the TCA. The diameter of a 4-ply TCA is 1.6 mm, however the crimps used at the ends of the TCAs have a diameter of approximately 3 mm. Some additional space was required for the temperature sensor leads and air inlet. Thus, the smallest channel height and width were 4 mm and 6 mm, respectively.

Since the ideal height and width of the channel were unknown, Experimental Example 2 investigated the impact that changing these factors had on the performance of the TCA. Combinations of three heights and three widths were tested to determine if there was an effect from the height, the width, or the overall cross-sectional area (CSA) of the channel. Trial and error in making different sized channels revealed that there is some degree of variance in the size of the channel, even when the same fabrication procedure is followed. Thus, the size step was set to 2 mm to ensure that the sizes were distinct. The channels will be described as width-by-height, i.e., a 6×4 channel has a width of 6 mm and a height of 4 mm. The final channel sizes that were tested are the following: 6×4, 6×6, 6×8, 8×4, 8×6, 8×8, 10×4, 10×6, 10×8.

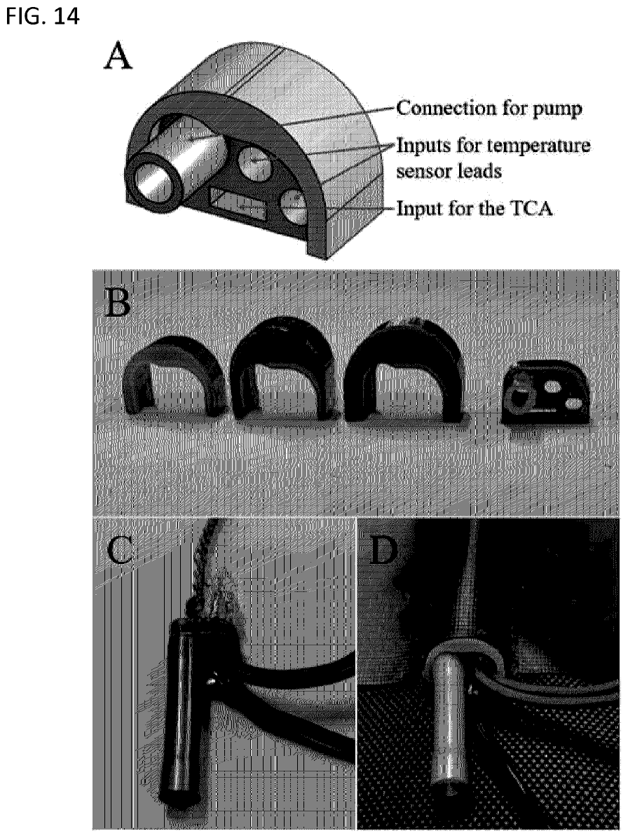

Prior to beginning the experiment, an inlet piece was designed to connect the channel, air pump, and TCA (shown in FIG. 14). It is composed of two parts: a small, central piece to attach all of the components, and a cover for the central piece that simplifies changing the size of the inlet to match the size of the channel. At this stage, the inlet was not permanently fixed to the channel to facilitate testing the channels with multiple TCAs. Instead, the inlet was deliberately created 2 mm wider and 0.5 mm taller than the desired dimensions of the channel and it was wedged into the channel inlet. The channel inlet was also created slightly larger than the body of the channel to accommodate the inlet.

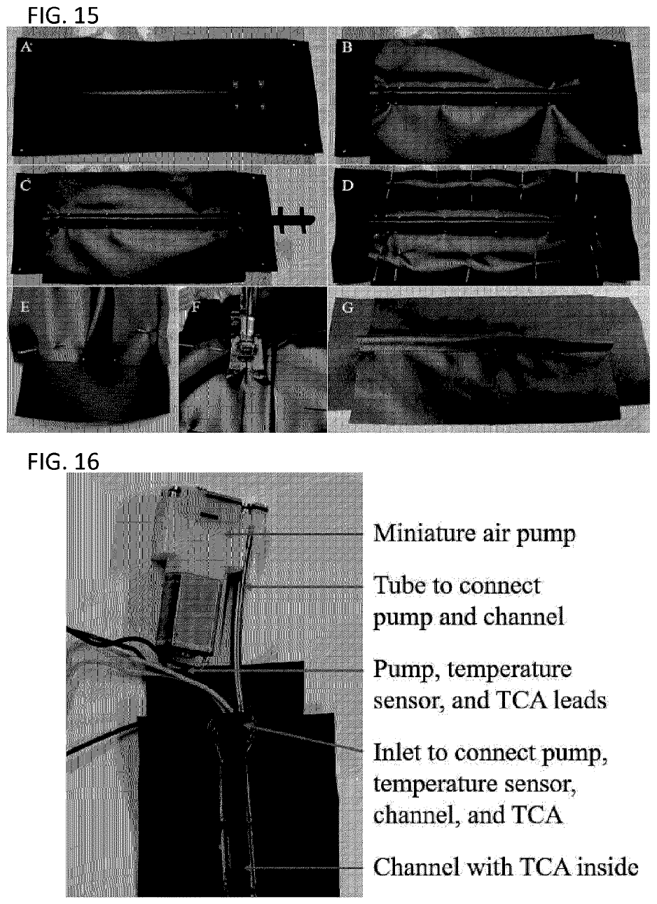

The channel fabrication process is outlined in FIG. 15 (steps A to G). To consistently create the channels, templates were designed and printed. Preliminary experimentation revealed that the channels were consistently wider and shorter than the desired dimensions, thus the templates were deliberately created 1 mm narrower and 0.5 mm taller. The channels were made to be 150 mm in length to accommodate TCAs that are 140 mm in length. The length of the channel was set to be approximately 10 mm longer than the loaded length of TCA to ensure that the entire TCA remained covered, as the TCA will creep slightly during use. The bottom layer is also sized longer than the desired length to simplify sewing.

The following steps (steps A to G) shown in FIG. 15 can be completed to create a channel: (A) The bottom layer and channel template are pinned in place to keep them from moving, and the inlet is placed at the end of the template. For simplicity, this is performed on a cardboard box to allow the pins to be pushed completely through the fabric. (B) The top layer of fabric is placed over the inlet and template, pulled taut, and pinned in place. (C) Before moving the template, the edge of the template is marked with pen as a guiding line for sewing. The template is slightly removed from the channel (to prevent it from getting trapped), and the end of the channel is pinned in place. (D) The two layers of fabric are pinned together to prevent them from slipping, and the channel is removed from the box. (E) To sew the channel, it must be flat along the seam. The fabric can be pulled taut and pinned in place at the outlet to help hold the opposite seam flat while starting to sew. (F) The seam is sewn along the guideline, while keeping the material pushed to the opposite side. (G) The previous two steps are repeated along the other side of the channel to obtain the finished product.

Finally, the channel on its own does not have enough insulation to protect the user from the temperatures reached by the TCA (up to 120 °C). The pain threshold for hot temperatures has been shown to be between 42 °C to 44.6 °C (22, 23), thus additional insulation is incorporated to keep the user comfortable. Thermal conductivity is a significant parameter for selecting insulation, as this parameter will dictate how thick the insulation must be to protect the user. Other properties were considered for the purpose of a wearable device, such as the water absorption (in case the user sweats) and density. Initially the Alpha SmartTemp Liner for prostheses was used, as the material is specifically designed to be comfortable for users when in contact with their skin for extended periods of time. This solution was tested by holding a TCA onto the material at approximately 110 °C for 5 minutes. It was found that two 8 mm layers were required to keep the temperature below 40 °C. Thus, alternative options were investigated.

While several types of insulation were considered, mineral wool was selected due to its low thermal conductivity and density. Samples of 3 mm mineral wool with a foil backing were obtained from Insultech Inc. When the foil side of the insulation was placed facing the TCA, the 3 mm insulation was sufficient to protect the user from the temperature of the TCA. For integration in a wearable device, there would have to be an additional layer underneath the insulation, as the insulation will pull apart from itself if left uncovered.

To summarize, the general design for the fabric channels is displayed in FIG. 16. The channel can be fixed to a wearable device by sewing it to an underlying garment, and the TCA can move freely inside the channel. Thus, the channel can both provide a means of cooling the TCA and a means of assembling it into a system. One end of the TCA was fixed to the channel inlet using the inlet piece described above, and the free end was coupled to its load using a thread as an artificial tendon. A flexible power line was also fixed to the free end of the TCA to allow the TCA to be actuated using Joule heating.

### Experimental Example 2: Methods

After the channel design was finalized, the impact of channel height and width on the performance of the TCA was investigated. This was accomplished by actuating TCAs in the nine channel sizes described above: 6×4, 6×6, 6×8, 8×4, 8×6, 8×8, 10×4, 10×6, and 10×8. TCA performance was assessed by comparing the cooling time, heating time, and stroke of the TCA in each sheath. For this experiment, the cooling time was defined as the time it takes the TCA to cool from 100 °C to 35 °C; the heating time was defined as the time to heat the TCA from 23 °C to 100 °C; and the stroke was defined as the difference between the maximum displacement of the TCA and its position when it returned to room temperature after the heating-cooling cycle. The cooling time was stopped at 35 °C because preliminary experimentation found that the air output from the pump increases in temperature and can reach up to 30.2 °C.

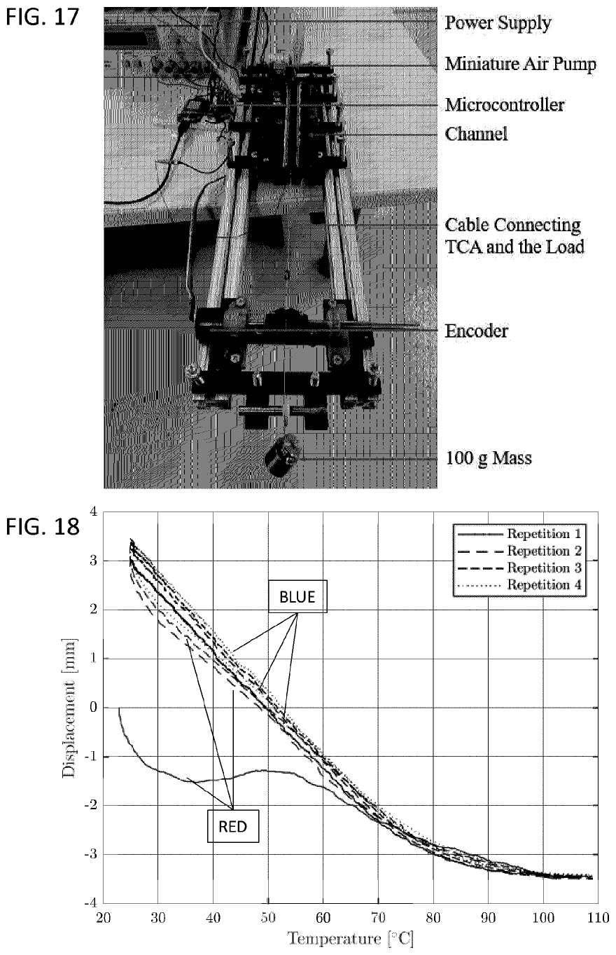

The experimental apparatus used for data collection is displayed in FIG. 17. Insulation was placed on the platform on which the TCA and the channel rested to mimic the construction of a wearable device. The TCA was attached to a previously developed module that combines pulse width modulation circuitry, a current sensor (ACS70331 EESATR-005U3), and a temperature sensor into one circuit board (14). A resistive temperature sensor detector consisting of a 40 AWG shielded copper wire wrapped around the TCA was used, since the temperature sensor must be able to fit within the channel without easily falling off, or compromising the ability of the TCA to move within the channel (14). The temperature sensor was located at the fixed end of the TCA to reduce the motion that could dislodge the sensor. The displacement of the TCA was measured using an encoder (AEAT-6012-A06) by fixing a string to the free end of the TCA and wrapping it around a pulley that was attached to the encoder. Set screws were used to prevent slipping between the string, the pulley, and the shaft. A 100 g mass was hung from the other end of the string to keep the TCA in tension. The TCAs were made using a previously developed methodology (14). Four-ply silver-coated nylon thread was obtained from VTechnicalTextiles (Part number: 260151023534) and was supercoiled with a load of 165 g. The coiled thread was plyed by folding it in half to prevent untwisting and the ends of the TCA were crimped to prevent the TCA from fraying using standard terminal crimps obtained from McMaster-Carr (Part ID: 69525K47). The untrained TCA length was 85 mm, and it was trained by stretching the artificial muscle 4-5 mm, holding it in position and heating the TCA at approximately 3 W until it reached 140 °C. This process was repeated until the TCA was 110 mm (around 30% longer), which resulted in a final, unloaded TCA length of 138 mm, as the crimps add 14 mm on either side of the TCA.

To collect the data, the TCA was centered in a channel, then heated from 23 °C to 100 °C at an average power of 2 W. The power was regulated to ensure that the heating time could be compared between samples, which was accomplished by controlling the duty cycle of the input voltage (12 V) to account for the change in resistance of the TCA. The resistance of the TCA was computed using R V/I, where R is the electrical resistance of the TCA, V is the average voltage applied to the TCA, and I is the average current through the TCA. Once the temperature of the TCA reached 100 °C, the power input to the TCA was stopped, and the miniature air pump was turned on at 12 V. The pump was left on until the TCA reached 35 °C, at which point the TCA was left to cool to room temperature passively, and the displacement of the TCA at room temperature was recorded before starting the next trial. This process was repeated three times before changing the channel. In total, 81 data points were collected at each channel size. To account for variability in the fabrication process, these repetitions were split evenly among three channels of the same size and three TCAs. The data collection process was blocked by TCA, i.e., all of the data were collected with TCA 1 before using TCA 2 or TCA 3.

Additionally, a warm-up procedure was completed if the TCA had not been used for more than 10 minutes, as it was noticed that the heating temperature-displacement curve for the heating cycle was significantly different if the TCA had not been used overnight, as seen in FIG. 18. The warm-up procedure consisted of heating and cooling the TCA between 23 °C and 100 °C until the difference between the starting and ending positions at 23 °C was less than 0.25 mm. This took 2-4 cycles, depending on how long it had been since the TCA was last used.

### Experimental Example 2: Results

After the data were collected, a statistical analysis was performed for each of the three parameters (cooling time, heating time, and stroke) to determine if there were differences between the channel sizes. First, the data were assessed using studentized residuals to determine if there were any outliers. Although the cooling time data had 5 outliers, it was not possible to remove them from the analysis, as there was no apparent reason for the variation. The heating time data had one outlier, which was removed, because in the immediate trial afterwards, the power line broke, and therefore it is very likely that the power line was already partially broken. The stroke data had no outliers. Then, the normality of the data was assessed using the standardized residuals with the Kolmogorov-Smirnov test, as the sample size was larger than 50. None of the data were normally distributed, thus Friedman tests were performed to determine if differences existed between the channels. The results of the Friedman tests stated that channel size had a significant effect on all three parameters, with p<0.001. Post hoc testing was performed using the Wilcoxon test, and a Bonferroni correction factor of 36 was applied to the p values to account for accumulated error from multiple comparisons, as 36 comparisons were performed for each parameter. The correction factor was applied by multiplying the p value by 36, to allow the significance threshold to remain at 0.05. The p values reported are those obtained after the correction factor was applied and the p values for all of the comparisons are reported in Table 5.

TABLE 5
Adjusted p values from the post-hoc testing-evaluating the impact of channel
height and width on TCA performance (values below 0.001 are reported as 0 and comparisons that
are not statistically significant are underlined).

| | Sheath | 6 × 4 | 6 × 6 | 6 × 8 | 8 × 4 | 8 × 6 | 8 × 8 | 10 × 4 | 10 × 6 | 10 × 8 |
|---|---|---|---|---|---|---|---|---|---|---|
| Cooling | 6 × 4 | — | 0 | 0.648 | 0.468 | 0 | 0 | 0 | 0 | 0 |
| Time | 6 × 6 | 0 | — | 0 | 0 | 1 | 1 | 0.108 | 1 | 0.025 |
| | 6 × 8 | 0.648 | 0 | — | 1 | 0 | 0 | 0 | 0 | 0 |
| | 8 × 4 | 0.468 | 0 | 1 | — | 0 | 0 | 0.004 | 0 | 0 |
| | 8 × 6 | 0 | 1 | 0 | 0 | — | 1 | 0 | 1 | 0 |
| | 8 × 8 | 0 | 1 | 0 | 0 | 1 | — | 0 | 1 | 0.051 |
| | 10 × 4 | 0 | 0.108 | 0 | 0.004 | 0 | 0 | — | 0 | 0 |
| | 10 × 6 | 0 | 1 | 0 | 0 | 1 | 1 | 0 | — | 0 |
| | 10 × 8 | 0 | 0.025 | 0 | 0 | 0 | 0.051 | 0 | 0 | — |
| Heating | 6 × 4 | — | 0.424 | 1 | 1 | 0.004 | 0.002 | 1 | 0 | 0 |
| Time | 6 × 6 | 0.424 | — | 1 | 0.014 | 1 | 1 | 0.005 | 0.003 | 0 |
| | 6 × 8 | 1 | 1 | — | 1 | 0.008 | 0.006 | 1 | 0 | 0 |
| | 8 × 4 | 1 | 0.014 | 1 | — | 0 | 0 | 1 | 0 | 0 |
| | 8 × 6 | 0.004 | 1 | 0.008 | 0 | — | 1 | 0 | 0.284 | 0 |
| | 8 × 8 | 0.002 | 1 | 0.006 | 0 | 1 | — | 0 | 1 | 0.002 |
| | 10 × 4 | 1 | 0.005 | 1 | 1 | 0 | 0 | — | 0 | 0 |
| | 10 × 6 | 0 | 0.003 | 0 | 0 | 0.284 | 1 | 0 | — | 1 |
| | 10 × 8 | 0 | 0 | 0 | 0 | 0 | 0.002 | 0 | 1 | — |
| Range | 6 × 4 | — | 0 | 0 | 0 | 0 | 0 | 0 | 0 | 0 |
| | 6 × 6 | 0 | — | 0.974 | 0 | 0.136 | 0 | 0 | 0.793 | 0.128 |
| | 6 × 8 | 0 | 0.974 | — | 0 | 1 | 1 | 0 | 1 | 1 |
| | 8 × 4 | 0 | 0 | 0 | — | 0 | 0 | 1 | 0 | 0 |
| | 8 × 6 | 0 | 0.136 | 1 | 0 | — | 0.251 | 0 | 0.917 | 1 |
| | 8 × 8 | 0 | 0 | 1 | 0 | 0.251 | — | 0 | 0.068 | 1 |
| | 10 × 4 | 0 | 0 | 0 | 1 | 0 | 0 | — | 0 | 0 |
| | 10 × 6 | 0 | 0.793 | 1 | 0 | 0.917 | 0.068 | 0 | — | 1 |
| | 10 × 8 | 0 | 0.128 | 1 | 0 | 1 | 1 | 0 | 1 | — |

First, the data were analyzed to determine which channel resulted in the best TCA performance. Ideally, one channel would have the lowest cooling and heating times and the highest stroke, however, the best channel is defined as the one that balances these three parameters. The best channel cannot simply be the one with the lowest cooling time if it also greatly increases the heating time or decreases the stroke, as this would have negative implications for a wearable device. Significant increases in heating time indicate that the channel causes the TCA to be less efficient, which would negatively impact the battery lifetime of a wearable device. Likewise, decreases in TCA stroke would negatively impact the performance of the device, as there would either be a lower achievable range of motion, or a longer TCA would be required to obtain the original stroke.

TABLE 6
Descriptive statistics for the parameters that were assessed to compare TCA
performance in channels with different dimensions (channels are ordered from left to right by
increasing cross-sectional area).

| Channel | | 6 × 4 | 8 × 4 | 6 × 6 | 10 × 4 | 6 × 8 | 8 × 6 | 10 × 6 | 8 × 8 | 10 × 8 |
|---|---|---|---|---|---|---|---|---|---|---|
| Cooling | Mean | 15.11 | 14.14 | 12.16 | 13.00 | 14.45 | 11.98 | 11.97 | 12.02 | 11.42 |
| Time | Standard | 2.28 | 2.52 | 2.10 | 2.30 | 3.08 | 1.93 | 1.53 | 1.91 | 1.33 |
| [s] | Deviation | | | | | | | | | |
| | Median | 15.30 | 13.70 | 12.35 | 12.64 | 14.46 | 12.16 | 12.25 | 11.87 | 11.30 |
| Heating | Mean | 5.36 | 5.36 | 5.18 | 5.39 | 5.27 | 5.10 | 4.98 | 5.07 | 4.88 |
| Time | Standard | 0.50 | 0.42 | 0.42 | 0.43 | 0.49 | 0.31 | 0.45 | 0.37 | 0.30 |
| [s] | Deviation | | | | | | | | | |
| | Median | 5.21 | 5.33 | 5.18 | 5.27 | 5.23 | 5.09 | 4.91 | 5.02 | 4.89 |
| Stroke | Mean | 7.04 | 7.53 | 8.14 | 7.41 | 8.29 | 8.29 | 8.25 | 8.42 | 8.32 |
| [mm] | Standard | 0.64 | 0.76 | 0.82 | 0.71 | 0.86 | 0.80 | 0.83 | 0.80 | 0.80 |
| | Deviation | | | | | | | | | |
| | Median | 7.11 | 7.59 | 8.07 | 7.43 | 8.31 | 8.18 | 8.37 | 8.55 | 8.34 |

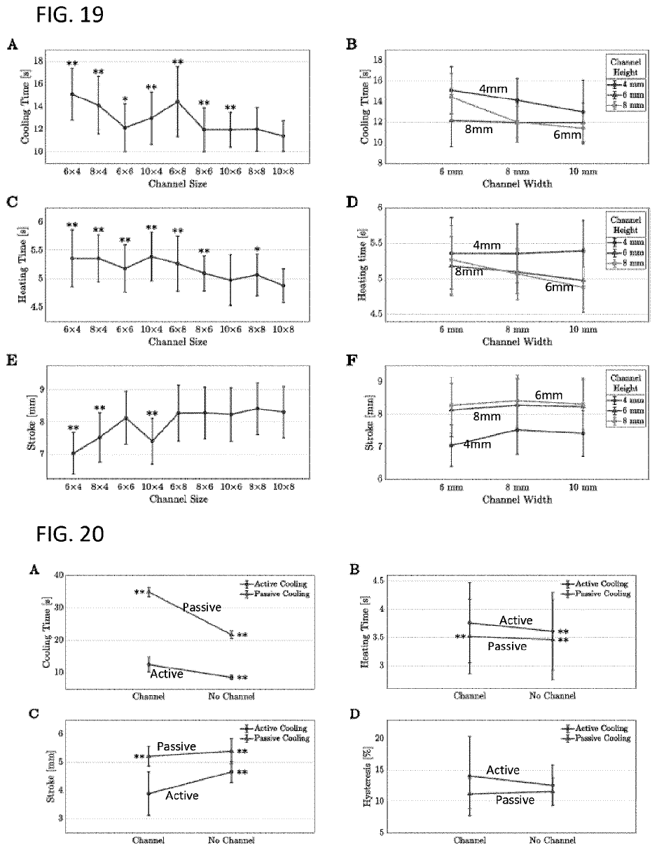

The descriptive statistics for each parameter are summarized in Table 6. To illustrate them, FIGS. 19A, 19C, and 19E plot the data with respect to increasing cross-sectional area (CSA), with the statistically significant differences for the 10×8 channel marked. It can be seen that for the cooling time, 10×8 is statistically different from all of the channels except 8×8 (11.42±1.33 s vs. 12.02±1.91 s, p=0.051), and for the heating time, 10×8 is significantly different from all of the channels except for 10×6 (4.88±0.3 s vs. 4.98±0.45 s, p=1). Furthermore, there is no statistically significant difference between the stroke for 10×8 and any channel with a height greater than 4 mm. Thus, it can be concluded that for a 4-ply TCA, the best channel out of the sizes present in this experiment is 10×8, as that channel has a good balance between cooling time and heating time, and a comparable stroke to the other sizes. While the cooling time for 10×8 is not statistically different from 8×8, 8×8 has a statistically higher heating time. Similarly, the heating time for 10×8 is not different from 10×6, however the cooling time for 10×6 is higher.

Next, the effect of width and height on the TCA performance was examined. To help visualize if there were any trends in the data based on height or width, the data were plotted with respect to these parameters in FIGS. 19B, 19D, and 19F.

FIG. 19B illustrates that the impact of changing the width and height of the channel was different at each level of height and width. These simple main effects were tested using additional Friedman tests, which stated that height had a significant effect at each width (p<0.001 for all three) and width had a significant effect for heights of 4 mm and 8 mm (p<0.001). The effect of width at a height of 6 mm was not significant (p=0.391).

At all widths, channels with a height of 4 mm (the blue points) had the highest cooling times. When the height was increased to 6 mm (the red points), there was a statistically significant decrease in the cooling time (p<0.001 for all widths). An additional increase in height to 8 mm (the yellow points) resulted in the average cooling time either decreasing further (10 mm width, p<0.001), remaining approximately the same (8 mm width, p=1), or increasing (6 mm width, p<0.001). There was no significant difference between 6×4 and 6×8 (p=0.648).

When analyzing the effect of width on the cooling time, there is a decrease in average cooling time as the width increases at 4 mm and 8 mm heights. At 4 mm (the blue line), the decrease in cooling time is significant when the width increases from 8 mm to 10 mm (p=0.004), however it is not significant between 6 mm and 8 mm widths (p=0.468). The opposite effect is observed at the 8 mm height (the yellow line)—the increase in width is significant between 6 mm and 8 mm (p<0.001), yet it is not significant between 8 mm and 10 mm (p=0.051).

If the data are regarded as average cooling time as a function of CSA, there is a slight downward trend as the CSA increases, with a Pearson correlation coefficient of −0.739 and a slope of −0.071 s/mm². Interestingly, the 6×8 and 8×6 channels have the same CSA, hence the stark difference between their mean cooling times (14.45±3.08 s vs. 11.98±1.93 s, p<0.001) highlights that the dimensions of the channel are important, not just the overall CSA.

Similarly, the heating time of the TCA slightly decreases as the channel CSA increases with a slope of −0.012 s/mm². For this parameter, the Pearson correlation coefficient is −0.884. Again, the difference between the heating times for 6×8 and 8×6 (5.27±0.49 s vs. 5.10±0.31 s, p=0.008) show that the height and width have an impact on the heating time, and these trends are illustrated in FIG. 19D.

From the simple main effect analysis for heating time, increasing the height of the channel did not have an effect when the width was 6 mm (p=0.177), yet there was an effect at widths of 8 mm and 10 mm (p<0.001 for both). Post hoc testing revealed that this effect was only present when the height increased from 4 mm (the blue points) to 6 mm (the red points), with p<0.001. There was no significant difference in the heating time when the height was further increased to 8 mm (the yellow point).

Likewise, the effect of width was not significant at a height of 4 mm (p=0.916), however, increasing the width produced a significant decrease in average heating time at heights of 6 mm (p=0.006) and 8 mm (p<0.001). At a height of 6 mm (the red line), the effect of increasing the width was only significant between 6 mm and 10 mm (p=0.003). However, at a height of 8 mm (the yellow line), the effect of width was significant at both step increases, with p=0.006 for 6 mm to 8 mm and p=0.002 for 8 mm to 10 mm.

The final parameter that was analyzed was the stroke of the TCA. Again, simple main effects were assessed using the Friedman test and the trends are shown in FIG. 19F. The effect of height was significant at all three widths (p<0.001 for all three), and the effect of width was significant at a height of 4 mm (p<0.001). Post hoc analysis revealed that the effect of height was only significant with the increase from 4 mm (blue points) to 6 mm (red points), with p<0.001 at all three widths. There was no significant effect on the stroke when the height was further increased to 8 mm. Similarly, the effect of width at 4 mm of height (the blue line) was only significant when the width increased from 6 mm to 8 mm (p<0.001). Thus, it appears that the channel dimensions did not significantly affect the stroke of the TCA, provided that the channel height was greater than 4 mm.

### Experimental Example 2: Discussion

This experiment demonstrated that TCA performance varied as the height and width of the channel changed. As illustrated in FIG. 19A there was a slight decrease in mean cooling time as the CSA of the channel increased, however this decrease is influenced by the dimensions of the channel. To decrease the cooling time of the TCA, the thermal resistance between the surface of the TCA and the environment needs to be reduced. The equation of thermal resistance for convective cooling, R_{conv}, is displayed in Equation 8, where h is the convective heat transfer coefficient and A_{T CA} is the surface area of the TCA that is exposed to forced convection (24). For a given TCA, the surface area would be fixed thus to decrease the thermal resistance h must be increased.

$${R}_{conv} = \frac{1}{{hA}_{TCA}} \qquad ( 8 )$$

The convective heat transfer coefficient depends heavily on the geometry of the hardware. For concentric cylinders, there is a complicated relationship between h and the diameters of the cylinders (24). It is hypothesized that the relationship between h and the dimensions of the channel would be even more complicated due to the half-elliptical shape and off-center placement of the TCA. However, for concentric cylinders, h is proportional to the input velocity of the fluid. It is assumed a similar relationship occurs with the channels—the cooling time will decrease as the input air velocity increases.

Fluid flow is also heavily dependent on geometry, and for laminar flow in a circular pipe, the flow resistance, R_{flow}, can be predicted using Pousuille's Law, which is shown in Equation 9. Here η is the viscosity of the fluid, l is the length of the tube, and r is the radius of the tube (25). While this equation cannot be directly applied to the channel, the understanding that flow resistance decreases as the pipe radius increases is assumed to be applicable.

$${R}_{flow} = \frac{8 η l}{π {r}^{4}} \qquad ( 9 )$$

The flow resistance will directly impact the fluid flow in a pipe, as for a fully developed laminar flow in a horizontal pipe, the flow, Q, is inversely proportional to the flow resistance and directly proportional to the pressure gradient across the pipe, ΔP, as seen in Equation 10 (25). It is also known that for pumps, there is an inverse relationship between the required pressure and the flow rate that the pump can output. Thus, given the limited pressure capabilities of the miniature pump, it is assumed that the cooling time decreased as the channel dimensions increased, because the lower flow resistance allowed the pump to provide a higher flow rate. This relationship was not linear, as the flow resistance, air velocity, and thermal resistance will depend on the specific geometry of the channel. Further work may quantify this relationship to help optimize channel dimensions for variety of applications.

$$Q = \frac{Δ P}{{R}_{flow}} \qquad ( 10 )$$

The effect that the specific height and width of the channel had on the cooling time of the TCA is highlighted by the contrast between the 6×8 and 8×6 channels. Despite the CSA being approximately the same, the cooling time for 6×8 was significantly higher and was the same as 6×4. This could be partially explained by observing the channel itself. The 6×8 channel was the only size where the height was larger than the width, and it was noticed that the sides of the channel had a tenancy to cave in slightly. This would reduce the effective CSA for the channel, increase the air resistance, and could increase the chance of the TCA coming in contact with the channel walls. Thus, it is recommended that the channel height should be the same or less than the channel width.

The geometry of the channel also influenced the heating time of the TCA. Unlike the cooling phase, a higher thermal resistance is better for the heating phase as this would reduce heat loss to the environment and reduce the heating time. As shown in FIG. 19C, the heating time decreased as the CSA increased, for which a possible explanation is that the additional stagnant air in the larger channels acted as better insulation and allowed less heat loss to the environment. This is consistent with the results found when TCAs were heated in rigid plastic tubes; as the tube diameter increased, the heating time constant decreased (17).

A noticeable exception to this trend are the channels with a 4 mm height—there was no difference in the heating times between the 6×4, 8×4, and 10×4 channels. A possible explanation is that due to the low height, the TCA was in contact with the top of the channel, and thus there was heat loss through the channel to the surrounding environment. These channels also had the lowest strokes, which supports the prediction that the TCA was in contact with the channel at the 4 mm height as the stroke could be reduced due to additional friction from increased contact with the channel walls. The 6×4 channel had a lower stroke than 8×4 and 10×4, which is likely due to additional contact with the channel sides.

As illustrated in FIG. 19F (red and yellow lines), the stroke was the same between the channels with 6 mm and 8 mm heights. This can be explained as once the TCA is no longer in contact with the top of the channel, there would be no additional frictional forces. The only significant difference occurred between 6×6 and 8×8 (8.14±0.64 mm vs. 8.42±0.80 mm, p<0.001). It is unclear why this occurred, as there was no difference between the heating time or cooling time for those two channels.

### Experimental Example 2: Reference List

1. Boulanger J, Lindsay M, Gubitz G, Smith E, Stotts G, Foley N, et al. Canadian stroke best practice recommendations for acute stroke management: Prehospital, emergency department, and acute inpatient stroke care, 6th edition, update 2018. International Journal of Stroke 13(2018)949-984.
2.Dworzynski K, Ritchie G, Fenu E, MacDermott K, Playford ED. Rehabilitation after stroke: summary of nice guidance. BMJ 346 (2013) f3615. doi:10.1136/bmj.f3615.
3. Kwakkel G, van Peppen R, Wagenaar RC, Dauphinee SW, Richards C, Ashburn A, et al. Effects of augmented exercise therapy after stroke: a meta-analysis. Stroke 35 (2004) 2529-2539.
4. Norouzi-Gheidari N, Archambault P, Fung J. Effects of robot-assisted therapy on stroke rehabilitation in upper limbs: Systematic review and meta-analysis of the literature. Journal of Rehabilitation Research and Development 49 (2012) 479-96.
5. Bertani R, Melgari C, Cola MCD, Bramanti A, Bramanti P, Calabro' RS. Effects of robot-assisted upper limb rehabilitation in stroke patients: a systematic review with meta-analysis. Journal of the Neurological Sciences 38 (2017) 1561-1569.
6. Maciejasz P, Eschweiler J, Gerlach-Hahn K, Jansen-Troy A, Leonhardt S. A survey on robotic devices for upper limb rehabilitation. Journal of Neuroengineering and Rehabilitation 11 (2014).
7. Desplenter T, Zhou Y, Edmonds BP, Lidka M, Goldman A, Trejos AL. Rehabilitative and assistive wearable mechatronic upper-limb devices: A review. Journal of Rehabilitation and Assistive Technologies Engineering 7 (2020).
8. Gandolla M, Antonietti A, Longatelli V, Pedrocchi A. The effectiveness of wearable upper limb assistive devices in degenerative neuromuscular diseases: A systematic review and meta-analysis. Frontiers in Bioengineering and Biotechnology 7 (2020).
9. Madden J, Vandesteeg N, Anquetil P, Madden P, Takshi A, Pytel R, et al. Artificial muscle technology: physical principles and naval prospects. IEEE Journal of Oceanic Engineering 29 (2004) 706-728.
10. Daerden F, Lefeber D. Pneumatic artificial muscles: actuators for robotics and automation. European Journal of Mechanical and Environmental Engineering 47 (2002).
11. Cappello L, Galloway K, Sanan S, Wagner D, Granberry R, Engelhardt S, et al. Exploiting textile mechanical anisotropy for fabric-based pneumatic actuators. Soft Robotics 5 (2018) 662-674.
12. Connolly F, Wagner DA, Walsh CJ, Bertoldi K. Sew-free anisotropic textile composites for rapid design and manufacturing of soft wearable robots. Extreme Mechanics Letters 27 (2019) 52-58.
13. Haines C, Lima M, Li N, Spinks G, Foroughi J, Madden J, et al. Artificial muscles from fishing line and sewing thread. Science (New York, N.Y.) 343 (2014) 868-872.
14. Edmonds BP. Feasibility of Twisted Coiled Polymer Actuators for Use in Upper Limb Wearable Rehabilitation Devices. Ph.D. thesis, Western University (2020).
15. Kianzad S. A Treatise on Highly Twisted Artificial Muscle: Thermally Driven Shape Memory Alloy and Coiled Nylon Actuators. Master's thesis, University of British Columbia (2015).
16. Yip MC, Niemeyer G. On the control and properties of supercoiled polymer artificial muscles. IEEE Transactions on Robotics 33 (2017) 689-699.
17. Edmonds BP, Trejos AL. Design of an active cooling system for thermally activated soft actuators. 16th IEEE International Conference on Rehabilitation Robotics (ICORR) (Toronto, Canada) (Jun. 24-28, 2019), 368-373.
18. Lizotte A, Trejos AL. Evaluation of a fabric channel cooling apparatus for twisted coiled actuators. Canadian Conference on Electrical and Computer Engineering (Halifax, Canada) (Sep. 18-20, 2022). Accepted.
19. [Dataset] American Academy of Audiology. Levels of noise. https://audiology-web.s3.amazonaws.com/migrated/NoiseChart Poster-%208.5x11.pdf 5399b289427535.32730330.pdf (2012). Last accessed 23 May 2021.
20. Tsuji W, Yoshida K, Asahara S. The coefficients of friction of various fibers by roeder's method. Sen'i Gakkaishi 41 (1985) T211-T220.
21. Lin TA, Lou CW, Lin JH. The effects of thermoplastic polyurethane on the structure and mechanical properties of modified polypropylene blends. Applied Sciences 7 (2017) 1254.
22. Greene LC, Hardy JD. Adaption of thermal pain in the skin. Journal of Applied Physiology 7 (1962) 693-696.
23. Defin R, Shachal-Shiffer M, Hadgadg M, Peretz C. Quantitative somatosensory testing of warm and heat-pain thresholds: The effect of body region and testing method. The Clinical Journal of Pain 22 (2006) 130-136.
24. Incropera FP, Dewitt DP, Bergman TL, Lavine AS. Fundamentals of Heat and Mass Transfer (John Wiley and Sons), 6 edn. (2007).
25. Urone PP, Hinrichs R, Dirks K, Sharma M. College Physics (OpenStax) (2012).

### Experimental Exemplification: Experimental Example 3

This experiment follows from Experimental Example 2, and the channel design is the same as that described above in Experimental Examples 2. This experiment compares the performance of the TCA with and without the fabric channel cooling apparatus.

### Experimental Example 3: Methods

As concluded in Experimental Example 2, the channel height and width impact the performance of the TCA, and for a 4-ply TCA, the best size out of those tested was the 10×8 channel. An additional evaluation was completed to compare the performance of the TCA with and without the fabric channel to determine the efficacy of the channel in cooling the TCA and its impact on TCA performance. To accomplish this, TCA performance will be compared across the following four cases: 1) active cooling with the channel, 2) active cooling without the channel (current state-of-the-art), 3) passive cooling with the channel, and 4) passive cooling without the channel (basic operation).

This experiment was completed using the same apparatus as Experimental Example 2. The experimental procedure was also very similar to that of Experimental Example 2, however two changes were made to be more consistent with how the TCAs and channels would be used in practice. The first change was to reduce the maximum temperature from 100 °C to 85 °C, as the temperature-displacement curve consistently flattened at around 85 °C. This is likely due to the coils of the TCA coming in contact with one another and preventing further contraction. The second change was to immediately begin the next heating-cooling cycle once the TCA reached 35 °C. Thus, the experimental procedure is summarized by the following steps: 1) the TCA was heated to 85 °C, without any active cooling; 2) the TCA was cooled to 35 °C, with or without active cooling (depending on the case); 3) Steps (1) and (2) were repeated five consecutive times; and 4) the data from the first repetition were discarded as the TCA was heated from room temperature, as opposed to 35 °C. For each case, 96 repetitions were collected, which were split evenly among four TCAs and, where applicable, among three 10×8 channels (the same ones that were utilized in Experimental Example 2), to account for variability in the fabrication procedure. The order of the cases was randomized for each TCA, and the data were blocked such that all of the data were collected on one TCA before moving to the next.

To assess TCA performance, the cooling time, heating time, stroke, and maximum hysteresis were recorded and compared between the cases. For this experiment, the cooling time was defined as the time it takes to cool the TCA from 85 °C to 35 °C; the heating time was defined as the time to heat the TCA from 35 °C to 85 °C; the stroke was defined as the difference between the maximum displacement and the position of the TCA at 35 °C at the end of the cooling phase; and the maximum hysteresis was defined as the largest difference in TCA position between the heating and cooling curves. The amount of hysteresis was computed by calculating the absolute difference between the position of the TCA at each point on the heating curve and the equivalent point (closest in temperature) on the cooling curve. The largest difference was recorded and was divided by the stroke for that trial, to express the maximum hysteresis as a percent of the stroke. Comparing the hysteresis as a percent of stroke reduces the possibility that a significant difference in the amount of hysteresis between cases exists solely due to a difference in TCA stroke.

### Experimental Example 3: Results

The descriptive statistics for the four parameters are displayed in Table 7. After the data were collected, they were checked for outliers using the studentized residuals. There were no outliers in the cooling time, heating time, or stroke data. There were two outliers present in the hysteresis data, however they were left in the analysis as there was no apparent reason for the variation.

The normality of the data was assessed using the Kolmogorov-Smimov test on the standardized residuals. Once again, the data were not normally distributed, therefore Friedman tests were conducted to determine if a statistically significant difference existed in the data. The Friedman test revealed that there was a significant difference present for each parameter, with p<0.001 for cooling time, heating time, and stroke and p=0.041 for hysteresis. Post hoc testing was completed using the Wilcoxon test and a Bonferroni correction factor of 6 was applied to the p values in the same manner as Experimental Example 2 to account for multiple comparisons. The adjusted p values for all comparisons are presented in Table 8.

TABLE 7
Descriptive data for Experimental Example 3.

| | | 1. Channel | 2. No Channel | 3. Channel | 4. No Channel |
|---|---|---|---|---|---|
| Case | | Active Cooling | Active Cooling | Passive Cooling | Passive Cooling |
| Cooling | Mean | 12.54 | 8.57 | 34.92 | 21.71 |
| Time | Std. Deviation | 2.31 | 0.71 | 1.48 | 1.24 |
| [s] | Median | 12.17 | 8.68 | 34.90 | 21.72 |
| Heating | Mean | 3.76 | 3.61 | 3.52 | 3.46 |
| Time | Std. Deviation | 0.71 | 0.69 | 0.66 | 0.71 |
| [s] | Median | 3.50 | 3.41 | 3.39 | 3.32 |
| Stroke | Mean | 3.89 | 4.66 | 5.21 | 5.40 |
| [mm] | Std. Deviation | 0.77 | 0.37 | 0.35 | 0.44 |
| | Median | 4.08 | 4.66 | 5.21 | 5.41 |
| Maximum | Mean | 14.06 | 12.59 | 11.23 | 11.60 |
| Hysteresis | Std. Deviation | 6.30 | 3.19 | 2.38 | 2.15 |
| [%] | Median | 12.02 | 12.20 | 11.42 | 11.56 |

TABLE 8
Adjusted p values from the post-hoc testing for Experimental Example 3-
comparison of TCA performance with and without the channel (values below 0.001
are reported as 0 and comparisons that are not statistically significant are underlined).

| | | 1. Sheath | 2. No Sheath | 3. Sheath | 4. No Sheath |
|---|---|---|---|---|---|
| | Case | Active Cooling | Active Cooling | Passive Cooling | Passive Cooling |
| Cooling | 1 | — | 0 | 0 | 0 |
| Time | 2 | 0 | — | 0 | 0 |
| | 3 | 0 | 0 | — | 0 |
| | 4 | 0 | 0 | 0 | — |
| Heating | 1 | — | 0 | 0 | 0 |
| Time | 2 | 0 | — | 0 | 0 |
| | 3 | 0 | 0 | — | 0.013 |
| | 4 | 0 | 0 | 0.013 | — |
| Range | 1 | — | 0 | 0 | 0 |
| | 2 | 0 | — | 0 | 0 |
| | 3 | 0 | 0 | — | 0.004 |
| | 4 | 0 | 0 | 0.004 | — |
| Hysteresis | 1 | — | 1 | 0.120 | 0.180 |
| | 2 | 1 | — | 0.012 | 0.048 |
| | 3 | 0.120 | 0.012 | — | 0.648 |
| | 4 | 0.180 | 0.048 | 0.648 | — |

FIG. 20 plots the data obtained in this experiment with the statistically significant differences for Case 1 marked. Interestingly, Case 1 is significantly different from all other cases for cooling time, heating time, and stroke, with p<0.001 for all comparisons. Conversely, there is no significant difference between the amount of hysteresis present in Case 1 and the other cases (p=1, p=0.120, and p=0.180, when compared with Case 2, 3, and 4, respectively), however Case 1 has approximately twice the standard deviation.

These data illustrate that the channel successfully reduced the cooling time of the TCA, however this occurred at a cost of increasing the heating time and decreasing the stroke. When the cooling time is compared to basic operation (Case 4, no channel with passive cooling), the cooling apparatus reduced the average cooling time by 42% (from 21.71±1.24 s to 12.54±2.31 s, p<0.001). The cooling time was also compared with the performance in a channel without active cooling (Case 3) to simulate the cooling time in a wearable device if active cooling was not employed. In this instance, the addition of active cooling reduced the cooling time by approximately 64% (34.92±1.48 s to 12.54±2.31 s, p<0.001). Finally, to complete the study, the cooling time of the TCA in the channel with active cooling (Case 1) was compared to the current state of the art: active cooling without a channel (Case 2). Unfortunately, the cooling time for Case 1 was larger than the cooling time for Case 2 (12.54±2.31 s vs. 8.57±0.71 s, p<0.001), however Case 2 is not feasible for wearable devices as the exposed TCA could burn the user or become caught on objects in the environment. A cooling time closer to that of Case 2 may be obtainable with further improvements to the channel design.

Ideally, improvements to the channel will also allow the TCA heating time and stroke to be closer to the values obtained without a channel. Surprisingly, the heating time of the TCA increased with the addition of the channel, however this difference was relatively small-approximately 4% between Cases 1 and 2, or 9% between Cases 1 and 4. A larger drawback is the decrease in stroke, as the addition of the channel caused reduced the stroke by approximately 19% between Case 2 and Case 1 (4.66±0.37 mm vs. 3.76±0.77 mm, p<0.001). Interestingly, the cases with passive cooling obtained higher strokes, even when the channel was present. With passive cooling, the addition of the channel reduced the stroke by 3.5% (5.40±0.44 mm vs. 5.21±0.35 mm, p=0.004).

### Experimental Example 3: Discussion

Unsurprisingly, the two cases with passive cooling had longer cooling times, and Case 3 (with the channel) had the largest cooling time. In Case 3, there would be minimal air circulation, and the air itself would also have to cool, since it would be warm from the end of the heating phase. Conversely, the other cases had some means of air circulation, whether it be from the pump when active cooling was incorporated in Cases 1 and 2, or natural circulation from the hot TCA being exposed to the environment in Cases 2 and 4. It is hypothesized that the cooling time for Case 2 was lower than that of Case 1 due to the lack of channel allowing constant natural convection (especially during the heating phase) in addition to the forced convection from the pump. Natural convection would provide an advantage, as the air that is heated during the heating phase can immediately move away from the TCA, as opposed to being trapped by the channel, reducing the surrounding temperature. Additionally, Case 2 likely has a higher air flow rate than Case 1, as there is no added flow resistance from the channel.

It is also possible that there was additional air flow in Case 2 due to air entrainment. Air entrainment is the phenomenon of air in the environment being pulled (entrained) along the air stream due to the pressure gradient, which increases the total air flow. Air entrainment would be prevented when the channel was used, as the inlet was sized such that the channel was sealed. Thus, further work may improve channel design by not sealing the inlet of the channel, to allow air entrainment, or by adding small holes in the channel, to allow natural convection.

One of these modifications may be sufficient to reduce the heating time with a channel to what it was without a channel, as the difference was less than 10%. The increase in heating time with the addition of the channel was unexpected, as it was predicted that the stagnant air inside the channel would act as insulation during the heating phase and allow the heating time to be reduced, as natural convection would not occur to the same extent. However, it is possible that the difference in heating times occurs from the addition of active cooling, not the channel. The difference in mean heating time with and without active cooling is 0.24 s with the channel and 0.15 s without the channel. In contrast, the difference in mean heating times with and without the channel is 0.15 s for active cooling and 0.06 s for passive cooling.

While the difference in heating time with the channel present was small, the addition of the channel and active cooling greatly reduced the stroke of the TCA. This likely stems from a combination of additional friction (when compared to Case 2) and a shorter cooling time (when compared to Case 3). The shorter cooling time would negatively affect the stroke, as preliminary experimentation found that the TCA, when loaded, has a tendency to slowly creep. Thus, the cases with passive cooling achieved higher strokes as the TCA has more time to extend, and it is predicted that this is the reason why the stroke for Case 3 is comparable to that of Case 4, despite the addition of the channel. On the other hand, the stroke for Case 2 is smaller than those of Cases 3 and 4, as the TCA does not have time to creep.

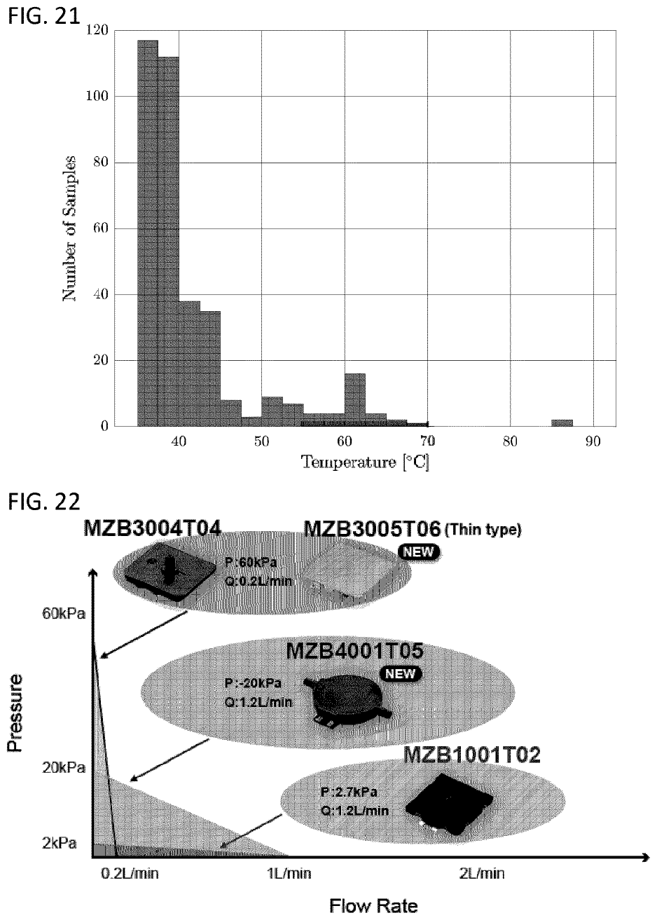

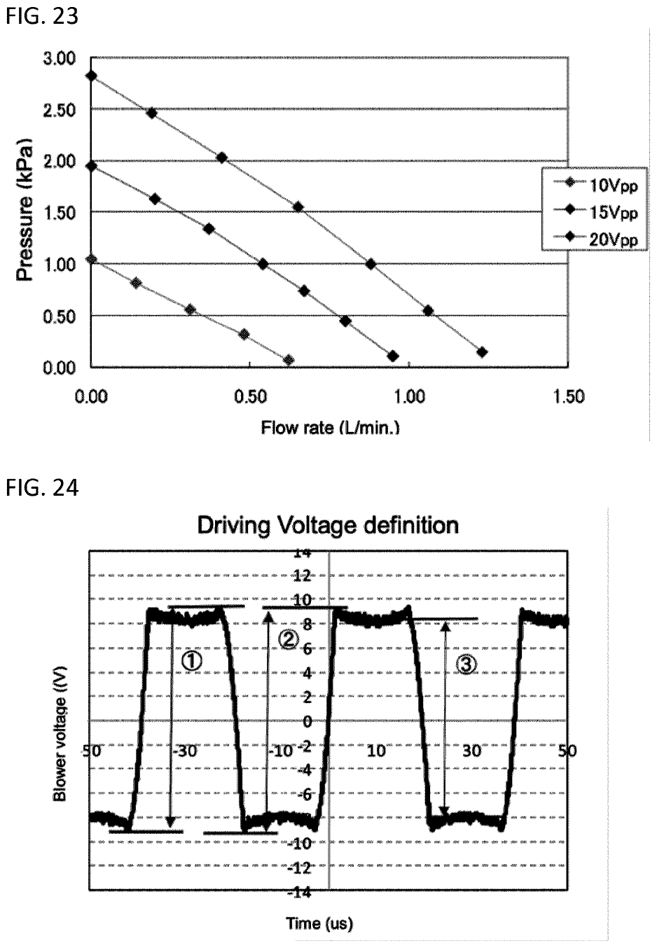

Despite the reduction in stroke, there was no significant difference in the amount of hysteresis present between Cases 1 and 2. There was also no significant difference in the hysteresis between Cases 3 and 4 (p=0.648), indicating that the addition of the channel does not increase the amount of hysteresis present in the system. However, the standard deviation for Case 1 has approximately twice the standard deviation compared to the other cases, suggesting that the behavior of the TCA may be harder to predict and model, as there is more variation. Interestingly, the majority of the samples had the maximum hysteresis occur between 35-40 °C, as seen in FIG. 21. A possible explanation is that when the power is turned on, the sudden increase in temperature causes a quick contraction, however when cooling, the progression over the same positions occurs more gradually. This is likely related to the heat transfer rates, as at the end of the cooling cycle, the reduced temperature differential results in reduced heat transfer.

### Experimental Example 3: Reference List

Same as Reference List for Experimental Example 2 (see above).

### Experimental Exemplification: Experimental Example 4: Further Work

The primary disadvantage to the currently disclosed design is that air pumps are noisy. Their volume approaches that of conversation, which some users may find difficult to ignore. This is especially a concern for applications in stroke rehabilitation, where many patients are elderly and may be more sensitive to environmental noise. This problem could be overcome by continuing to investigate other means of circulating air. It is possible that a larger fan could overcome the flow resistance of the channel and achieve the same air flow rate with less noise.

Another means of circulating air would also be advantageous if the air pressure or air flow could be increased, without sacrificing the portability of the system. Increasing the air flow would allow the cooling time of the TCA to be further reduced, and increasing the air pressure would ensure that this design could work for longer TCAs that would require longer channels. Further work could investigate the relationship between the channel dimensions and air flow to aid with pump selection.

Experimental Example 2 determined that the best dimensions for a channel, out of those tested, for a 4-ply TCA was 10 mm in width and 8 mm in height (10×8), which was the largest channel. It is possible that further increasing the size of the channel could further improve the performance of the TCA (i.e., reduce the cooling time). It is also likely that the ideal channel size will change depending on the TCA; for example, 2-ply TCAs are considerably smaller than 4-ply TCAs, and the optimal channel dimensions for them could be a smaller channel size.

Other sources of variation in the results come from differences in the TCAs and channels due to the fabrication procedure and placement of the TCA in the channel. It was observed that once a TCA was in a channel, the parameters were reasonably consistent. However, if the TCA was removed and put in the same channel, the values for the parameters were noticeably different. This indicated that the placement of the TCA in the channel is a source of variation in the results. A limitation of the current channel design is that there is no means to guarantee consistent placement, however, if this design was implemented in a wearable device, the TCA would not be repeatedly removed and replaced in the channel. Further work could devise a method of ensuring the TCA is centered in the channel, such as adding a guide.

Another minor source of error stemmed from the room temperature changing over the course of data collection. The room temperature varied between 21.2-23.5 °C (average of 21.8 °C) throughout Experimental Example 2 and 22.2-23.1 °C (average of 22.6 °C) during Experimental Example 3. This impacts the results as the ambient room temperature influences the temperature of the air being blown through the channel and the heat transfer rate between the TCA and the environment.

When collecting data, it was noticed that the temperature of the TCA continued to increase by 3-7 °C over 0.3-0.6 s after the power to the TCA was turned off. Since this effect was not observed when the temperature of the TCA was measured using a thermal camera, a possible explanation is incomplete contact between the temperature sensor and the TCA, resulting in slower heat transfer between them and hence a delay in the temperature sensor reading. This may be rectified by ensuring complete contact between the TCA and the temperature sensor by using a thermal paste, however, further work could perform more validation on the temperature sensor.

Further work could investigate improvement of the channel design, such as modifying the inlet, testing other materials, adding holes, or further increasing the dimensions. Additionally, other cross sectional shapes could be investigated with the addition of rigid supports to ensure that the channel remains open.

### Experimental Exemplification: Experimental Example 5: Quiet Air Flow Device

This Experimental Example follows from Experimental Example 4 and identification of a quieter air flow device as a further area of improvement. In this Experimental Example, we will delve into the design considerations and selection process of a piezo blower module. Experimental Examples 2 and 3 utilized a DC air pump (SP-16A-RO-DV), which offered a flow rate of approximately 1-1.5 L/min. However, one notable drawback was its high audibility. This pump was used as a baseline for comparison while evaluating other options. The final decision on the piezo blower module was based on multiple criteria, including power-to-weight ratio, power-to-volume ratio, power efficiency, noise level, total flow rate, total weight, total volume, and form factor.

An exemplified piezo blower module is obtained from Murata Manufacturing Co., Ltd. (Nagaokakyo, Kyoto, Japan). The Murata product line for piezo pumps is depicted in FIG. 22. Two particular models, the MZB4001T05 and the MZB1001T02, stand out for their superior flow rates. Notably, the MZB4001T05 model delivers a higher pressure than the MZB1001T02. When compared to products with similar form factors from other manufacturers, these two models exhibit competitive specifications. According to the Pressure-Flow Rate chart, the MZB4001T05 model offers the highest performance. However, as this model has not yet been released for purchase, we could not place an order. As a result, we opted for the MZB1001T02 model instead.

Table 9 presents the calculated metrics comparing the chosen piezo blower and the DC pump that was used in Experimental Examples 2 and 3. The piezo blower matches the DC pump in total flow rate and efficiency (η), yet surpasses it significantly in terms of the power-to-weight ratio (PWR) and power-to-volume ratio (PVR). Additionally, the piezo blower operates with considerably lower noise.

However, there is a drawback to using the piezo blower: it operates at a lower pressure compared to the DC pump. This disadvantage may be mitigated by selection of fabric properties, adjustment of number of pumps/blowers, and placement of pump inlets along the channel's length. Also, other piezo blowers may be purchased to mitigate or even eliminate this disadvantage (for example, the noted Murata MZB4001T05 blower).

TABLE 9
Comparison of the selected Murata blower and a DC pump used in previous tests.

| | Volume | Weight | Flow | Pressure | | | | | | Noise |
|---|---|---|---|---|---|---|---|---|---|---|
| Pump | (cm3) | (g) | (L/min) | (kPa) | Pₒᵤₜ | PWR | PVR | Pᵢₙ | η | (dB) |
| SP 16A-RO- | 30.77 | 38.5 | 1.3 | 10 | 0.22 | 5.63 | 7 | 5 | 0.043333 | 60 |
| DV | | | | | | | | | | |
| MZB1001T02 | 0.74 | 1.4 | 1.2 | 2.5 | 0.05 | 35.7 | 68 | 1.2 | 0.041667 | 25 |

Operating a piezo blower effectively requires stimulating it with a high voltage, between 20 to 30V, at its resonant frequency. For the MZB1001T02 model, the datasheet indicates this frequency to be around 25 kHz. The voltage level used impacts the amplitude and, consequently, the output power, which is demonstrated by the flow rate-pressure curve shown in Error! Reference source not found.3. Moreover, to achieve the desired outcome, we aim to drive the piezo element using a square wave at a manufacture recommended voltage. This approach helps to mimic the curve illustrated in FIG. 24.

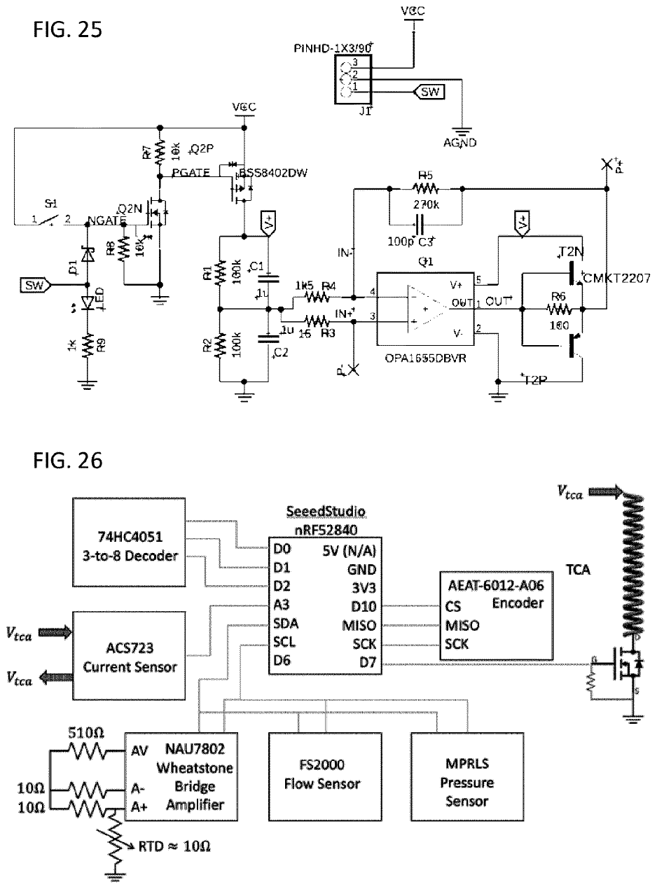

To generate the targeted square wave, Murata suggested using the Astable Multivibrator driver circuit. We tested this circuit in a laboratory setting and made slight modifications to include a high side switch. This switch can be manipulated either manually with a physical button or digitally through a low voltage signal from a microcontroller. Additionally, we installed a status LED to give visual confirmation whenever the circuit is activated by the low voltage signal. The resulting circuit schematic is shown in FIG. 25.

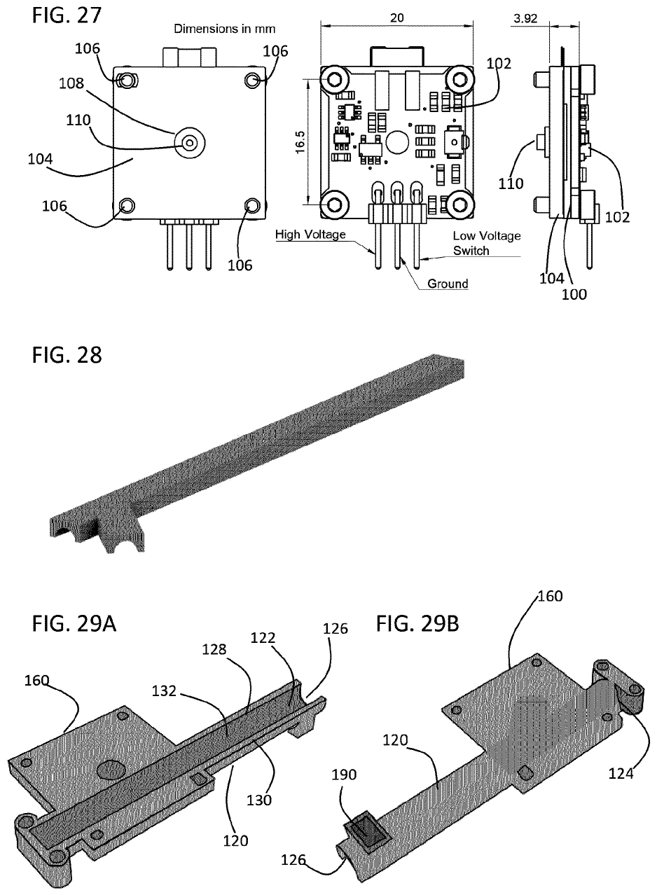

In order to assemble the piezo blower 100 and its corresponding driving circuit 102 into a single unit, displayed in FIG. 27, we designed a thin mechanical spacer 104 that does not obstruct the air flow. FIG. 27 shows, from left to right, an elevation bottom, elevation top view and elevation side view of the combined piezo blower and driving circuit module. The spacer forms four corner openings 106 to receive fasteners (such as threaded bolts) for mounting the piezo blower 100 to an inlet interface of the flexible channel. The spacer also forms a central opening 108 to provide clearance for the piezo blower outlet 110 to extend and mate with an inlet port of the inlet interface.

FIG. 26 illustrates a circuit diagram for a testing apparatus to test performance of a piezo blower in cooling a TCA. The components included in the setup are as follows:
1. 3-to-8 Decoder: This I/O expansion device enables the control of multiple Piezo Blower modules and TCAs, facilitating efficient testing and data collection.
2. ACS723 Current Sensor: The ACS723 current sensor is utilized to track power consumption, allowing for precise measurements of energy usage during the experimental process.
3. Adafruit NAU7802 Wheatstone Bridge Amplifier: This component is used to measure the temperature from a Resistive Temperature Detector (RTD), providing accurate temperature data for analysis.
4. FS2000 Flow Sensor: The FS2000 flow sensor is employed to measure airflow rates, an essential parameter in the study of TCAs and their performance.
5. Adafruit MPRLD Pressure Sensor: This pressure sensor is utilized to measure pressure levels within the system, contributing valuable information for CFD analysis validation.
6. AEAT-6012-A06 Magnetic Encoder: The AEAT-6012-A06 magnetic encoder tracks the movement of the TCA, enabling precise monitoring of its motion during testing.

The resistor circuit connected to the Wheatstone Bridge amplifier comprises a 510Ω current limiting resistor and two 10Ω resistors. This setup is designed to match the estimated resistance of a 1-meter strand of 40 AWG (≈10Ω) wire that is folded and wrapped along the entire length of the TCA (Twisted Coiled Actuator).

The process of folding the wire before wrapping it around the TCA is crucial, as it effectively cancels out the induced voltage resulting from the heating current passing through the TCA. This technique helps to minimize any unwanted interference and ensures accurate measurements of the TCA's resistance.

### Experimental Exemplification: Experimental Example 6: Thermoplastic Polymer Partial Pipe Component of a Flexible Channel

This Experimental Example follows from Experimental Example 4 and identification of a additional structural support to maintain an open channel as a further area of improvement. In this Experimental Example, a partial pipe is 3D printed on a fabric in the orientation shown. For testing purposes, we found that a simple circular tube wall might not have enough top surface material, so the partial pipe was “squared off” on its exterior surface and enclosed in a rectangular shaped extrusion. The partial pipe includes a side port that extends an arbitrary distance from the main tube at a 45-degree angle and is meant to support a 4 mm outer diameter (OD) pneumatic inlet tube.

An example of Slicer and Printer setting for 3D printing are provided to illustrate a fabrication technique.

Slicer Procedure. 1) Import STL file into Prusa Slicer. 2) Orient so that the tube wall is on the top side of the fabric as shown in FIG. 28. XY rotation and translation is minimized. The orientation of the fabric and the location of the alligator clips for securing the fabric should be considered (see printing procedure section below). 3) Choose layer height under “Print Settings” drop down and choose “ColorFabb VarioShore TPU @Template” in the “Filament” drop down. 4) Go to the “Print Settings” tab at the top and check “Avoid crossing perimeters”. 5) Go to “Filament Settings” tab and change extrusion multiplier to a value between 0.6 and 0.7. The most foaming occurs at 220 C and the least at around 190 C. Flow rate should be as low as 0.6 and as high as 1.0 to accommodate foaming. 6) Click the “Slice” button. 7) Export Slicer code to the USB drive.

Printing Procedure. 1) The build plate for the Prusa Mini is 20×20 cm so and therefore cut the selected fabric to be printed on to be 20 cm long and/or wide to be clipped to the build plate. 2) Adjust the Z-height upwards to compensate for the fabric. This takes some trial and error but is typically between −1.00 and −1.50 mm. 3) Insert the USB obtained in step 7 of the Slicer Procedure and start the printing process. Do not mount the fabric yet. The printer needs to run the calibration process first. 4) Once the calibration is complete and the printer will start the purge line procedure. As soon as the purge line is complete, hit the pause button. You want to do this after the purge line, since the mounting clips would otherwise get in the way of the print head. 5) With the purge line complete and the print paused, mount the fabric using alligator clips. 6) Resume the printing process and actively adjust the z-height during the first layer so the material is injected into the fabric. 7) The printer should now be left alone until the print is complete.

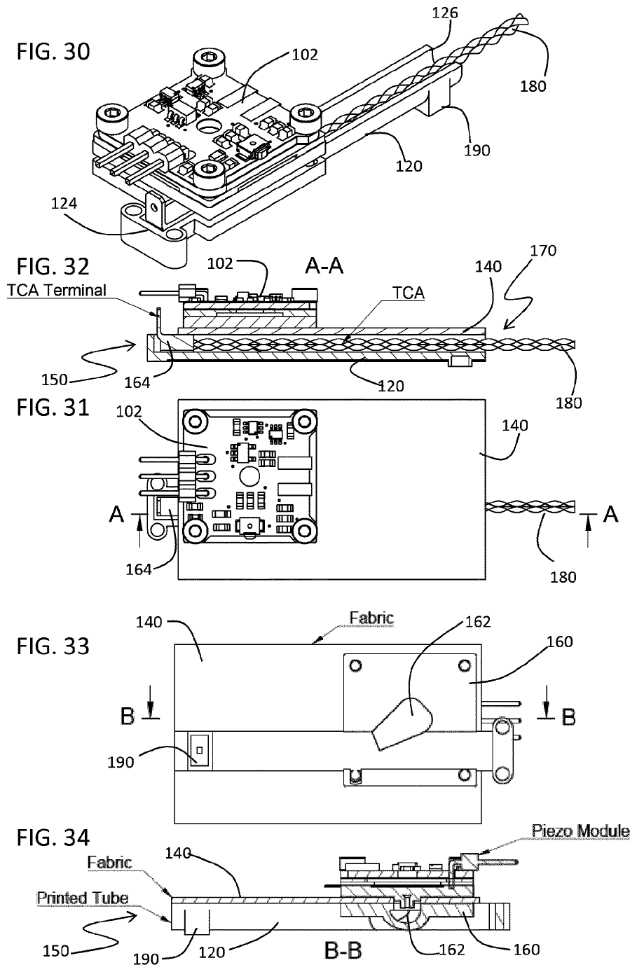

Effectiveness and compact nature of using 3D printed foam partial pipe piece to construct channels on fabric and piezo blowers for active cooling was demonstrated by developing a forearm sleeve featuring four parallel TCA channels. The initial focus was on designing and optimizing the anchor points for each channel to ensure a snug fit for directly mounting the piezo module in proximity to the TCA for a compact profile, as shown in FIG. 29A and FIG. 29B and FIG. 30.

The flexible channel comprises a flexible partial pipe piece 120 of tubular shape defining an interior trough shaped as an interior concave surface 122 bound by a first end 124 and a second end 126. The interior trough is open from the first end to the second end to permit air flow to communicate from the first end to the second end. The first end may be open, closed or partially open as desired, while the second end will provide an opening for either a TCA 180 or a wire/cable attached to the TCA to pass through to connect with a target load.

The tubular shape of the flexible partial pipe piece 120 can be formed with opposing first and second edges (128, 130) defining a longitudinal slot/opening 132 that extends along an axial length of the partial pipe piece 120 and is attached to a flexible flat fabric piece 140. In FIGS. 31 to 34, the tubular shape of the flexible channel 150 is shown as the partial pipe piece 120 (more specifically, the partial pipe is a half pipe) that is closed along its axial length by a flattened side provided by the flexible flat fabric piece 140, such that the radial cross-sectional shape presents as semi-circular or semi-elliptical at any point along the axial length of the flexible channel. The flexible channel 150 has a similar radial cross-sectional shape along its axial length such that cross-sectional shapes at various points along the length of the lumen are similar to cross-sectional shapes at the first end and the second end. However, variation of radial cross-sectional shape along the axial length of the flexible channel 150 may be accommodated and in certain examples may confer a benefit. Cross-sectional shapes other than semi-circular or semi-elliptical, for example a square cross-sectional shape characterizing a rectangular cylinder tubular shape of a flexible channel, may be accommodated and in certain examples may confer a benefit. Typically, the cross-sectional shape will include at least one flattened side.

An inlet interface 160 is integrated near the first end of the flexible channel. The inlet interface 160 providing one or more ports for communicative access between an exterior of the flexible channel 150 and its interior lumen. The one or more ports are formed as through-holes or bores within the inlet interface 160. A first port 162 provides an inlet for air flow. A second port 164 provides an attachment point for an artificial muscle fibre and access for electrical leads to connect to the artificial muscle fibre.

While the first end of the flexible channel is closed or partially closed by the inlet interface 160, the second end 126 of the flexible channel forms an outlet opening 170 that provides an outlet to exhaust air flow and an outlet for the artificial muscle (such as TCA 180) or a cable or wire connected to the artificial muscle to pass through to connect with a targeted load, such as a hand, a finger, or any other application known in the field of soft robotics. A mounting receptacle 190 for installing a temperature sensor is formed on the exterior surface of the partial pipe piece near the second end 126. This dedicated space for attaching a temperature sensor (such as a TPiS-1S 1385 contactless IR sensor), enables the accurate measurement of the TCA's temperature during operation.

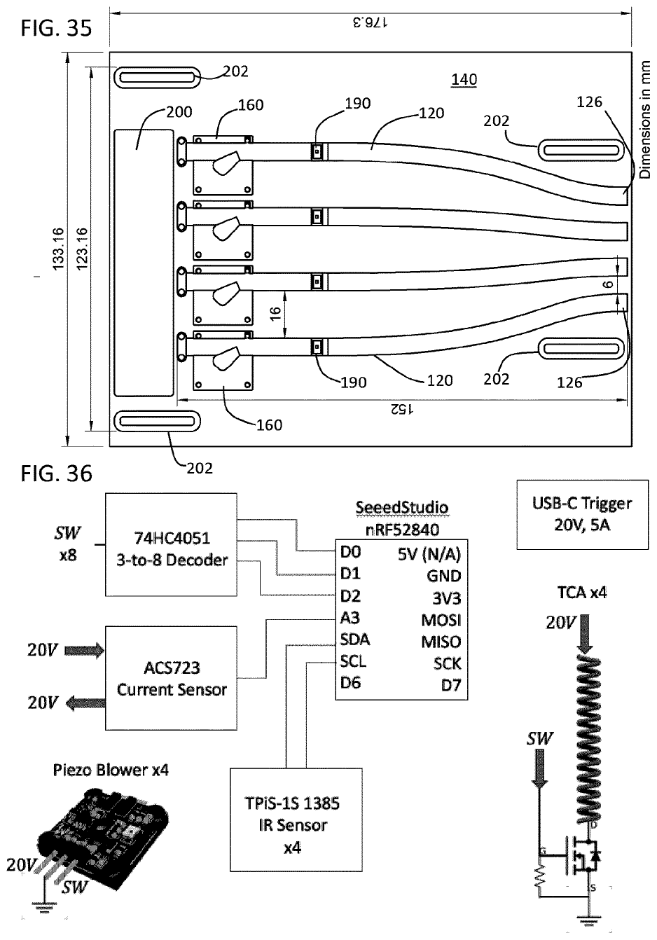

The advantage of creating this mount design first lies in its replicability. It can be easily copied multiple times within a larger assembly, allowing for the extrusion of second end 126 and its defined outlet 170 in any desired shape, as depicted in FIG. 35. For example, a plurality of flexible partial pipe pieces 120 each integrating an inlet interface 160 can be 3D printed directly onto flexible fabric 140 sized and shaped as a forearm brace. A flexible supporting bar 200 is provided for supporting electronics to drive and control mounted TCA and piezo blowers, and supporting buckles 202 and corresponding straps are incorporated to secure the flexible fabric in the form of a forearm brace to a forearm of a subject.

Through this design approach, we demonstrate the versatility of using 3D printed foam partial pipe pieces to construct channels on fabric and incorporating piezo blowers for active cooling, showcasing the potential applications and adaptability of this technology.

Electronics to drive and control TCA and piezo blowers mounted in the forearm brace are illustrated in FIG. 36 as an electrical schematic, which include a 3-to-8 decoder to control 4 TCAs and 4 Piezo Blowers, an ACS723 current sensor to monitor and regulate power consumption, 4 TPiS-1S-1385 IR sensor modules, and a USB-C trigger to provide 20V and 5 A to the system through a standard USB-C power bank.

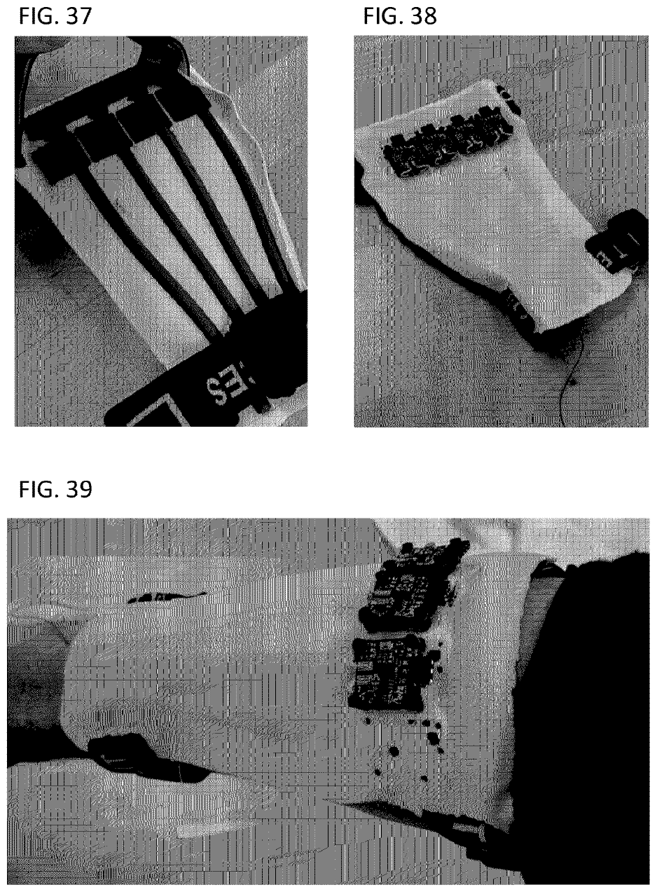

FIGS. 37 to 39 show various views of the constructed forearm brace. FIG. 37 shows an interior view of the constructed forearm brace that faces and may contact a subject's skin when strapped in an operational position to a forearm. FIG. 38 shows an exterior view of that faces away from the subject's skin. FIG. 39 shows the constructed forearm brace in an operational position strapped to the forearm of the subject, with each respective TCA configured and controlled to expand/contract through each respective lumen defined by the flexible channel and exit through the second end 126 and its defined outlet 170 to connect to a desired load, such as a finger. For example, each finger connecter may be in the form of a ring or a sleeve mounted on the finger with the TCA connected to the ring/sleeve (or any intervening wire/cable/filament or the like extending from the TCA and connecting to the ring/sleeve) with any conventional connector or fastener.

### Experimental Exemplification: Experimental Example 7: Energy Harvesting to Provide Air Flow

Energy harvesting can be incorporated into the cooling system as a source of supplementary or primary source of air flow by configuring a body suit comprising pumps, valves, and/or bladders to generate and direct air flow to the flexible channel and TCA. For example, if any electronic air flow device, such as a piezo blower, is deemed to produce insufficient airflow for a particular implementation, energy harvesting provides an option to augment or even fully replace the micro blowers with one-way valves placed at specific locations around the body. This would create a system that enhances air circulation without the need for additional bulky components.

Below are approximate calculations for the flow rate (Q), pressure (p), and output power (Pout) that could be harvested from the sole of a shoe when walking. These calculations are based on the following assumptions:
Sole dimensions: 5×20×3 cm, resulting in a total volume (V) of 300 cm\hat{ }3.
Compression factor (CF): 50%
Body weight ( ): 60 kg
Steps per minute: 30

The computations for each metric are as follows:
1. Flow rate (Q): To calculate the flow rate of air that could be harvested from the shoe sole, we multiply the compression factor by the volume and the steps per minute:

$$Q = CF * V * \frac{Steps}{min} \qquad ( 11 )$$

2. Pressure (p): The pressure exerted on the shoe sole can be estimated by dividing the body weight by the surface area of the sole:

$$p = \frac{mg}{A} \qquad ( 12 )$$

3. Output power (Pₒᵤₜ): The output power that could be harvested is calculated by multiplying the flow rate and the pressure:

Pₒᵤₜ=Q*/p (13)

These calculations provide initial approximations and may require further refinement based on specific design considerations and further experiments. The shoe pump metrics (Table 10) were then compared to the metrics of the DC pump used in previous Experimental Examples and the Murata piezo blower product lineup, as seen in Table 11.

TABLE 10
Energy Harvesting Metrics-Shoe Form.

| | |
|---|---|
| Sole Width (cm) | 5 |
| Sole Length (cm) | 20 |
| Heel Thickness | 3 |
| (cm) | |
| Sole Volume | 300 |
| (cm3) | |
| Compression | 0.5 |
| Litres/Step | 0.15 |
| Steps/Min | 30 |
| Flow (L/min) | 4.5 |
| Person Weight | 60 |
| (kg) | |
| Area of Sole (m3) | 0.1 |
| Pressure (Pa) | 5886 |

TABLE 11
Comparison of Energy Harvesting Shoe Form to Commercial Air Flow Devices.

| | Volume | Weight | Flow | Pressure | Output | | |
|---|---|---|---|---|---|---|---|
| Pump | (cm3) | (g) | (L/min) | (Pa) | Power | PWR | PVR |
| SP 16A-RO-DV | 30.77 | 38.5 | 1.3 | 10000 | 0.22 | 5.63 | 7 |
| MZB1001T02 | 0.74 | 1.4 | 1.2 | 2500 | 0.05 | 35.7 | 68 |
| MZB3004T04 | 1.356 | 3.5 | 0.2 | 60000 | 0.20 | 57.1 | 147 |
| MZB4001T05 | 3.08 | N/A | 1.3 | 20000 | 0.43 | N/A | 141 |
| MZB3005T06 | 0.8303 | 2 | 0.2 | 60000 | 0.20 | N/A | 241 |
| Shoe Pump | 600 | 300 | 4.5 | 5886 | 0.44 | 1.47 | 0.7 |

While a shoe pump is illustrated, other form factors of generating energy to power air flow devices may readily be accommodated. Regardless of the particular apparatus used for generating energy, the air flow device is communicative with the energy generating device so as to harvest energy from forces produced by motion of the body. The energy may be produced using any known device or machine, including for example a positive displacement pump or a bellow pump.

### Experimental Exemplification: Experimental Example 8: Mathematical Model and Control Algorithm

The concept of thermal resistance was employed to represent the overall heat transfer rate across a Twisted Coiled Actuator (TCA) actuation system using a single term, Rtot. This allowed for easy validation of T_{TCA} through experimental measurements of the TCA surface temperature (T_{TCA}) and the ambient temperature (T∞), using the following equation:

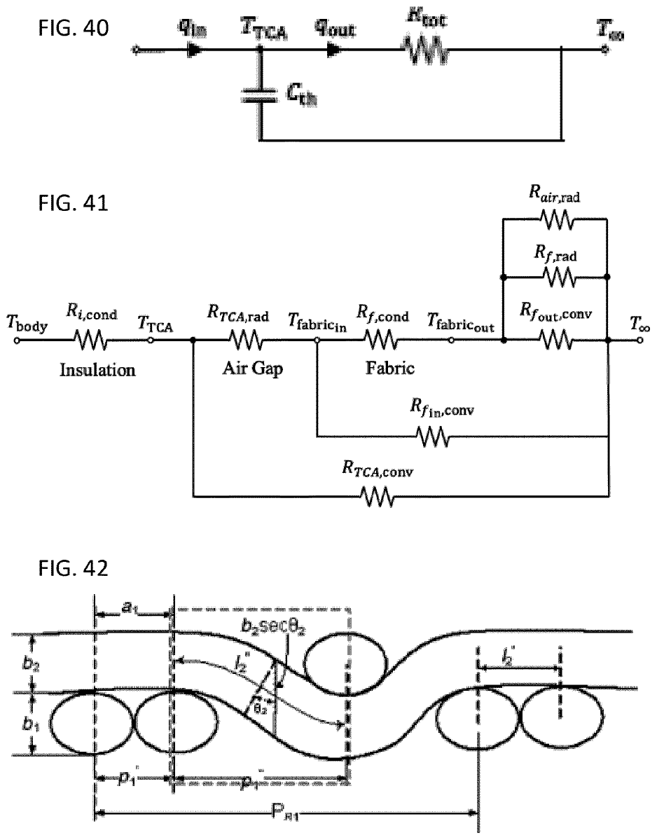

T_{TCA}−T_{∞}=PᵢₙRₜₒₜ (14)

where Pin is a known power input used to heat the TCA strand through resistive heating. By configuring the thermal model into a circuit diagram (FIG. 40), the properties describing each thermal resistance can be carefully chosen to control the steady state temperatures as any node in the system.

Note that to remove the spatial aspect of the TCA body during both transient and steady-state analysis, it was represented as a lumped thermal capacitance (Cth) with uniform thermal distribution across its axial and radial directions. The lumped capacitance method is suitable when the overall resistance experienced at the surface of the TCA (Rtot) greatly surpasses the internal conductive thermal resistance of the TCA (R_{TCA}). To use the lumped capacitance model, the Biot number (Bi), which represents the ratio between these resistances, should be less than 0.1, as indicated in Equations 15 and 16.

$$Bi = \frac{{R}_{TCA}}{{R}_{tot}} < 0.1 \qquad ( 15 )$$

$${R}_{TCA} = \frac{{L}_{c}}{{k}_{TCA} {A}_{TCA}} \qquad ( 16 )$$

Here, Lc can be assumed to be equal to the diameter of the TCA (d_{TCA}), and k_{TCA} shows the thermal conductivity of the TCAs, which was considered to be 4.6 Wm-1 K-1 from Sun et al. 2018. A_{TCA} is the TCA surface area calculated from Equation 4 by approximating the TCA as a double helix.

A_{TCA}=mnNπ²d_{TCA}²\sqrt{1+(φ_{TCA}/πd_{TCA})²} (17)
n: the number of TCA strands piled together,
φ_{TCA}: the TCA pitch (m),
N: the number of turns (N=L_{TCA}/φ_{TCA}),
L_{TCA}: the length of the TCA (m),
d_{TCA}: the diameter of the TCA (m),
m: a calibration factor to account for additional surface area produced by the TCAs complex structure.

The total thermal resistance, described by Rtot, acts radially from the TCA surface, where the stored thermal energy is described as a single lumped capacitance, Cth, and the surface temperature of the TCA is represented as T_{TCA}. Equation 18 describes Cth in terms of the volumetric density, ρ, the volume (calculated using the nominal thread radius and untwisted length of 1.2 m), V, and the specific heat, c. By assuming that Joule heating is the only source of input energy, qin was equated to the electrical input power, Pin. Therefore, the energy balance equation can be described by Equation 19, where the solution to θ in the time domain is represented in Equation 20, and θi is the initial potential temperature between the TCA and environment, or T_{TCA}−T_{∞}.

$${C}_{th} = ρ Vc \qquad ( 18 )$$

$${C}_{th} \frac{dT}{dt} = {P}_{in} - \frac{{T}_{TCA} - {T}_{∞}}{{R}_{tot}} \qquad ( 19 )$$

$$θ = {θ}_{i} {e}^{\frac{- t}{τ}} + {P}_{in} {R}_{tot} ( 1 - {e}^{\frac{- t}{τ}} ) \qquad ( 20 )$$

Equation 20 can then be used to compute the temperature of the TCA at any time, t. Here, τ is the thermal time constant of the system, which is described as a function of Rtot and Cth given by the following equation:

τ=CₜₕRₜₒₜ. (21)

The complete heat transfer model includes the TCA body, an air gap, which air is flowing freely through, a fabric wall, an insulation wall, and the ambient environment. FIG. 41 illustrates the equivalent thermal resistance circuit for the cooling phase, where the thermal resistance of woven fabrics can be calculated using a lumped model wherein the yarns, interlacements, and air pores in a fabric can be treated as a system of resistances.

The equivalent thermal resistance circuit during the cooling phase consists of the following:
1. Ri,cond: the thermal conductivity resistance through the insulation wall,
Tbody: the body temperature (°C),
Q: the heat flow through the insulation (W),
Lcins: the characteristic length of the insulation (m),
Kins: the thermal conductivity of the insulation (Wm\hat{ }−1 K\hat{ }−1)(\hat{ } denotes exponent),
Ains: the insulation surface area.

$${R}_{i , cond} = \frac{{T}_{TCA} - {T}_{body}}{Q} = \frac{{L}_{{c}_{ins}}}{{K}_{ins} {A}_{ins}} \qquad ( 22 A )$$

2. R_{TCA},rad: the thermal resistance due to radiation at the surface of the TCA,
εTCA: the emissivity (εTCA=0.85) [2],
σ: the Stefan Boltzman's constant (5.67×10-8 Wm\hat{ }−2K\hat{ }−4) (\hat{ } denotes exponent).

$${R}_{TCA , rad} = \frac{1}{{ε}_{TCA} σ {A}_{TCA} ( {T}_{TCA} + {T}_{∞} ) ( {T}_{TCA}^{2} + {T}_{∞}^{2} )} \qquad ( 22 B )$$

3. RTCA,conv: the convection resistance at the TCA,
hTCA: the convection coefficient
kair: the thermal conductivity of air (kair=7.5(10−5)T+0.0242)(Wm\hat{ }−1 K\hat{ }−1),
Dh: the hydraulic diameter (m) (Dh=Din−dTCA),
Din: the inner diameter (m),
NuD: the Nusselt number (NuD=0.023Re45Pr0.3),
Re: the Reynolds number (Re=VairDeff/v),
Vair: the velocity of the air

$$( {V}_{air} = ( \frac{- 333.33 {D}_{in}^{z} + 5.5 {D}_{in} + 0.0745 ln ( p ) - 0.5038}{{A}_{h}} ) \times {10}^{- 3} )$$

was measured using an Omega Mass Flow Meter, against the inner diameter, Din, and inlet pressure, p (kPa), and fitted using linear regression to obtain the hydraulic area [3],
Deff: the effective diameter (m)

$$( {D}_{eff} = \frac{2 {D}_{h}}{ζ} ) ,$$

ζ: the dimensionless parameter

$$\cdot ( ζ = \frac{{( {D}_{in} - {d}_{TCA} )}^{2} ( {D}_{in}^{2} - {d}_{TCA}^{2} )}{{D}_{in}^{4} - {d}_{TCA}^{4} - {( {D}_{in}^{2} - {d}_{TCA}^{2} )}^{2} / ln ( {D}_{in} / {d}_{TCA} )} ) ,$$

Ah: the hydraulic area (m\hat{ }2)

$$( {A}_{h} = {π ( \frac{{D}_{in}}{2} )}^{2} - n {π ( \frac{{d}_{TCA}}{2} )}^{2} = \frac{π ( {D}_{in}^{2} - {nd}_{TCA}^{2} )}{4} ) .$$

$${T}_{TCA , conv} = \frac{1}{{h}_{TCA} {A}_{TCA}} \qquad ( 23 )$$

4. Rf,cond: the thermal conductivity resistance through the fabric [4],

The model has been divided into two main stages. The first stage comprises defining the fabric geometry and using a common mathematical equation which can be used on all the basic weaves. The second stage comprises finding the effective resistance due to conduction.
4.1. Stage 1: Defining fabric geometry

### Variables:

a: the major axis of the ellipse formed by the yarns (m); a=d/e,
b: the major axis of the ellipse formed by the yarns (m); back scatter fraction; b=d·e,
A: the area of the fabric surface (m\hat{ }2),
C: the radiative cross sections (m\hat{ }2),
d: the diameter of the circular yam; in the case of ply, resultant diameter (m),
D: the sum of warp and weft diameters, (m),
deff: the effective diameter of yarn
df: the diameter of fibre (m),
e: the coefficient of flattening,
h: the total vertical displacement of warp or weft (m),
h′: the total vertical displacement of warp or weft (m),
h″: the total vertical displacement of warp/weft in the intersection region (m),
l: the number of intersections in a repeat,
k: the conductivity of the material (Wm\hat{ }−1 K\hat{ }−1); scattering, absorption, and extinction coefficients
l: the modular length of warp or weft (m),
l′: the modular length of warp/weft in the float region (m),
l″: the modular length of warp/weft in the intersection region (m),
N: the total number of fibres per unit length of a fibrous web,
p: the pacing between two warps/wefts (m),
p′: the spacing between two warps and wefts in the float region (m),
p″: the spacing between two warps/wefts in the intersection region (m),
Q: the heat flow through the fabric (W); radiative efficiencies,
R: the number of yarns in a repeat; resistance to heat flow,
t: the thickness of the total fabric (m),
T1,2: the temperature of the hot and cold surface (K),
x: the size factor,
ε: the emissivity of the surface,
θ: the angle of intersection of warp and weft (rad),
λ: the wavelength of radiation (μm),
σ: the Stefan Boltzmann's constant (5.66×10−8 W/m2 K4),
Ø: the porosity of yarn,
ω: the ratio of extinction to scattering coefficients.

### Subscripts

1, 2: the denote warp and weft respectively,
i,j: the surfaces,
s: the factor of scattering,
α: the factor of absorption,
ζ: the factor of extinction.

### Assumptions

1. The fabric behaves like a plain weave in the intersections; therefore, Peirce's geometry [5] can be considered to be valid.
2. The pressure applied to the yarn is same everywhere. Hence the degree of flattening of the yarns is the same in the intersections as well as floats.

Hence from assumption (2) and FIG. 42, the coefficient of flattening (e) can be calculated:

$$e = \frac{{h}_{1} + {h}_{2}}{{d}_{1} + {d}_{2}} \qquad ( 24 )$$

$${h}_{1} = \frac{4}{3} {p}_{2} \sqrt{{c}_{1}}$$

$${h}_{2} = \frac{4}{3} {p}_{1} \sqrt{{c}_{2}}$$

$${c}_{1} = \frac{{l}_{1} - {p}_{2}}{{p}_{2}}$$

$${c}_{2} = \frac{{l}_{2} - {p}_{1}}{{p}_{1}}$$

$$e = \frac{{h}_{1}^{″} + {h}_{2}^{″}}{{d}_{1} + {d}_{2}} = \frac{\frac{4}{3} [ {p}_{2}^{″} \sqrt{{c}_{1}^{″}} + {p}_{1}^{″} \sqrt{{c}_{2}^{″}} ]}{D} . \qquad ( 25 )$$

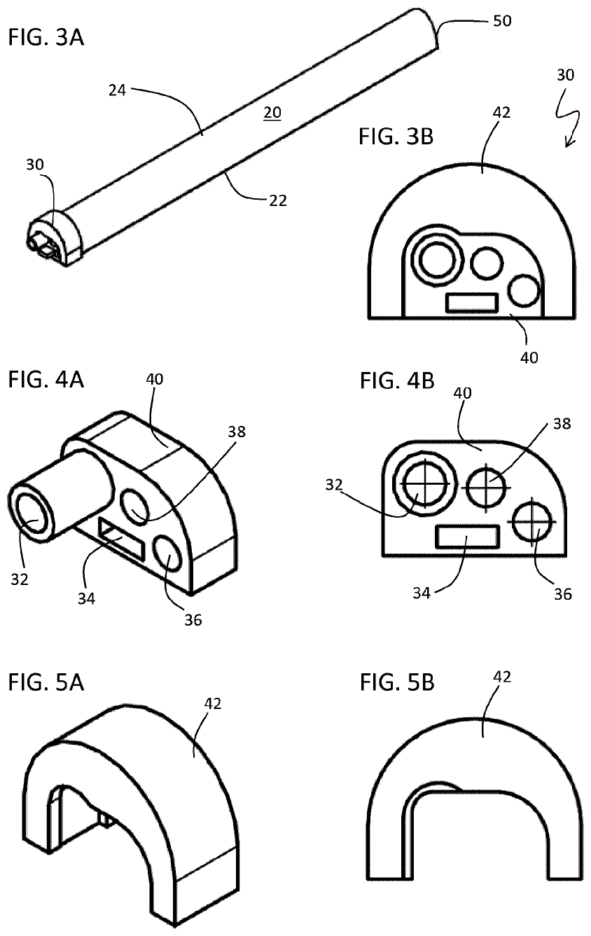

Now, P_{R}_{₁}=(R−I)p₁′+Ip₁″ from FIG. 3. Also p₁′≈a₁; therefore. average spacing between the threads p₁ is given by

$${p}_{1} = \frac{( R - I ) {p}_{1}^{′} + {Ip}_{1}^{″}}{R} .$$

which implies that P_{R}_{₁}=Rₚ_{₁}. Thus,

$${p}_{1}^{″} = \frac{{Rp}_{1} - ( R - I ) {a}_{1}}{I} \qquad ( 26 )$$

$${p}_{2}^{″} = \frac{{Rp}_{2} - ( R - I ) {a}_{2}}{I}$$

where

$${c}_{2}^{″} = \frac{{l}_{2}^{″} - {p}_{1}^{″}}{{p}_{1}^{″}} , {l}_{{R}_{2}} = ( R - I ) {l}_{2}^{′} + {I}_{2}^{″} ,$$

and l₂′≈a₁. Therefore, by substituting l and p, we get:

$${c}_{2}^{″} = \frac{{Rp}_{1} {c}_{2}}{{Rp}_{1} - ( R - I ) {a}_{1}} , \qquad ( 27 )$$

$${c}_{1}^{″} = \frac{{Rp}_{2} {c}_{1}}{{Rp}_{2} - ( R - I ) {a}_{2}} .$$

It is also known that t=h₁+b₁ or h₂+b₂. Assuming that t=h₁+b₁, we have h₁=h₁″; where

$${h}_{1}^{″} = \frac{4}{3} \cdot \frac{1}{I} \sqrt{{R}^{2} {p}_{2}^{2} {c}_{1} - {Rp}_{2} {c}_{1} ( R - I ) {a}_{2}} ,$$

and b₁=d₁·e. By combining both the terms and substituting in t=h₁+b₁ or h₂+b₂, we get:

$$t = \frac{4}{3 I} \sqrt{{R}^{2} {p}_{2}^{2} {c}_{1} - {Rp}_{2} {c}_{1} ( R - I ) \frac{{d}_{2}}{e}} + {d}_{1} \cdot e . \qquad ( 28 )$$

Solving this equation for e gives three values out of which the limits for coefficient of flattening are e≠0; e=t(e) where e≤l.

### Modified Diameters of Yarns:

It was assumed that the effective diameter in this case is the average of the flattened diameter and normal diameter.

$${d}_{eff} = \frac{{a}_{yarn} + {d}_{yarn}}{2} = {d}_{yarn} [ \frac{1 + e}{2 e} ] \qquad ( 29 )$$

### 4.2. Stage 2: Conductive Heat Transfer Through Fabric

### Assumptions

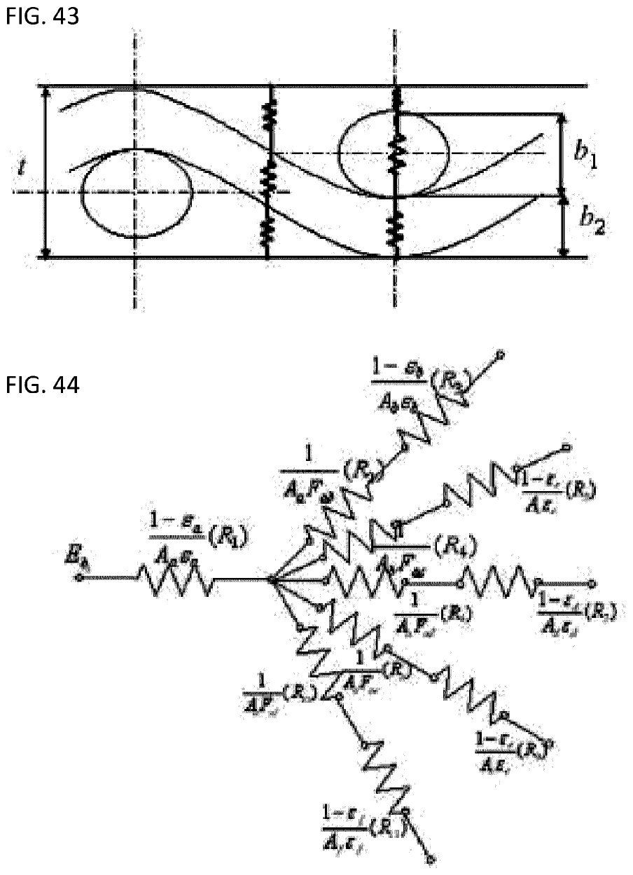

The assumptions made in this model are as follows:
1. This system can again be simplified as a system of resistances against conductive heat losses, i.e., heat loss occurs through the air pore, intersection and modular lengths of warp and weft.
2. In the present case with the absence of forced or natural convection, the air inside the fabric can be assumed to be another insulating material with same thermal conductivity and density values as that of air. The system of resistances is given in FIG. 43.
3. The yarn is a porous material and has both solid and fluid components.

The basic equation of conductive heat transfer (Fourier's law):

$$\frac{dQ}{d τ} = - kA \frac{\partial T}{\partial x} \qquad ( 30 )$$

This equation is integrated over a time r, then under steady state conditions,

$${Q}_{cond} = kA ( \frac{{T}_{1} - {T}_{2}}{t} ) . \qquad ( 31 )$$

Therefore, the conductive heat loss through modular lengths of warp and weft can be calculated by Equations 32 and 33.

$${Q}_{{m}_{1}} = \frac{{A}_{{m}_{1}} \cdot Δ T}{( \frac{{b}_{1} sec {θ}_{1}}{{k}_{1}} + \frac{t - {b}_{1} sec {θ}_{1}}{{k}_{air}} )} \qquad ( 32 )$$

$${Q}_{{m}_{2}} = \frac{{A}_{{m}_{2}} \cdot Δ T}{( \frac{{b}_{2} sec {θ}_{2}}{{k}_{2}} + \frac{t - {b}_{2} sec {θ}_{2}}{{k}_{air}} )} \qquad ( 33 )$$

Here, Aₘ_{₁}=R²a₁(p₂−a₂) and Aₘ_{₂}=R²a₂(p₁−a₁).

Furthermore, the conductive heat loss through the intersection and air pore are computed by Equations 34 and 35.

$${Q}_{st} = \frac{{A}_{st} \cdot Δ T}{( \frac{{b}_{1}}{{k}_{1}} + \frac{{b}_{2}}{{k}_{2}} + \frac{t - {b}_{1} - {b}_{2}}{{k}_{air}} )} \qquad ( 34 )$$

$${Q}_{a} = \frac{{A}_{a} \cdot Δ T}{( \frac{t}{{k}_{air}} )} \qquad ( 35 )$$

Here, Aₛₜ=R²a₁a₂ and Aₐ=R²(p₁−a₁)(p₂−a₂).

Therefore, the total heat loss due to conduction is:

Q_{cond}=Qₘ_{₁}+Qₘ_{₂}+Qₛₜ+Qₐ. (36)

Therefore, based on Equation 36, the total thermal conductivity resistance through the fabric is calculated by Equation 37.

$${R}_{f , cond} = \frac{Δ T ( {R}^{2} {p}_{1} {p}_{2} )}{{Q}_{cond}} \qquad ( 37 )$$

5. Rair,rad and Rf,rad: the radiation resistance at the air and fabric [4],

### Part 1: Radiative Heat Transfer Through the Air Pore [4]

### Assumptions

A few assumptions can be made safely:
1. The air gap is enclosed on four sides by yarns.
2. In the absence of convection, the upper surface can be assumed to be a still black body.

Based on the assumptions, the heat lost from the air gap due to radiation can be calculated by Equation 38, while the air gap is represented by a system of resistances, and the effective resistance (Reff) can be obtained by electrical network analogy (FIG. 44).

$${Q}_{rad} = \frac{σ ( {T}_{1}^{4} - {T}_{2}^{4} )}{{R}_{eff}} \qquad ( 38 )$$

$${R}_{eff} = {[ {R}_{1} + {( {R}_{2} + {R}_{3} )}^{- 1} + {( {R}_{4} + {R}_{5} )}^{- 1} + {( {R}_{6} + {R}_{7} )}^{- 1} + {( {R}_{8} + {R}_{9} )}^{- 1} + {( {R}_{10} + {R}_{11} )}^{- 1} ]}^{- 1} \qquad ( 39 )$$

From the above equations, the resistance due to radiation through the air gap per unit area is:

$${R}_{air , rad} = \frac{Δ T ( {R}^{2} {p}_{1} {p}_{2} )}{{Q}_{rad}} . \qquad ( 40 )$$

### Part 2: Radiative Heat Transfer Through Fabric [4]

### Assumptions

A few assumptions will be made in this regard:
1. The fibres are assumed to be infinitely long cylinders.
2. The modular lengths of warp and weft and the intersecting portion in a repeat can be simplified into a fibrous web occupying the same area and volume.
3. The thickness of the web is the weighted mean of the thicknesses of the warp, weft and intersection point.
4. The fibres are considered as participating media, i.e., they absorb, scatter and emit the radiation falling on them. Owing to the cylindrical shape of the fibres, anisotropic scattering takes place.
5. The web is considered to be optically thin.

Based on Wien's formula, the wavelength of the radiation is approximately 100 μm. The size factor can be obtained from the following equation:

$$x = \frac{π T}{λ} \qquad ( 41 )$$

With d≈135×10\hat{ }−5 m, the value of x becomes x=0.424. According to the theory of scattering [7], if x≤1, Mie scattering takes place [8]. Hence, the treatment of radiation of fibres in the web will be done according to Mie scattering by long cylinders. The linear anisotropic scattering theory (LAS) put forward by Tong and Tien [9] for lightweight insulations in moderate temperature was used for the presented model. The scattering, absorption and extinction coefficients were obtained with the help of Mie scattering equations [8, 10].

The coefficients of scattering, absorption and extinction in a random arrangement of fibres can be calculated as per the following equation:

k=Cₖ·N, (42)
k=s: scattering coefficient
k=α: assortation coefficient
k=ξ: extinction coefficient.

The total radiative heat flux for optically thin fibrous insulation as follows:

$${q}_{r} = \frac{σ ( {T}_{1}^{4} - {T}_{2}^{4} )}{1 + {γτ}_{0}} \qquad ( 43 )$$

$$γ = \frac{( 3 - ω {a}_{1} )}{4}$$

$${a}_{1} = 2 ( 1 - 2 b )$$

Therefore, the resistance due to radiation through the fabric can be obtained as:

$${R}_{f , rad} = \frac{Δ T}{{q}_{r}} \qquad ( 44 )$$

6. Rfin,conv and Rfout,conv: the convection resistance at the inner and outer of the fabric [6],

For laminar flow,

$${\overline{N}}_{{u}_{1}} = \frac{l {\overline{h}}_{1}}{k} = 0.664 {Pr}^{\frac{1}{3}} {{Re}_{L}^{\frac{1}{3}} [ 1 - {( \frac{{x}_{0}}{L} )}^{\frac{3}{4}} ]}^{\frac{2}{3}}$$

For turbulent flow,

$${\overline{N}}_{{u}_{1}} = \frac{l {\overline{h}}_{1}}{k} = 0.037 {Pr}^{\frac{1}{3}} {{Re}_{L}^{\frac{4}{5}} [ 1 - {( \frac{{x}_{0}}{L} )}^{\frac{9}{10}} ]}^{\frac{8}{9}}$$

The thermal resistance of the fabric in a natural and forced convective mode can be obtained by the following formula:

$${R}_{{f}_{in} , conv} = \frac{( {T}_{t} - {T}_{a} ) \cdot {A}_{t}}{{Q}_{t}} - {R}_{c} \qquad ( 45 )$$

$${R}_{c} = \frac{( {T}_{t}^{′} - {T}_{a} ) \cdot {A}_{t}}{{Q}_{t}^{′}}$$

### Total Thermal Resistance

Combining all the thermal resistance together:

$${R}_{tot} = \frac{1}{{R}_{TCA , conv}} + ( {R}_{TCA , rad} + ( \frac{1}{{R}_{{f}_{in} , conv}} + ( {R}_{f , cond} + ( \frac{1}{{R}_{air , rad}} + \frac{1}{{R}_{f , rad}} + \frac{1}{{R}_{{f}_{out} , conv}} ) ) ) ) .$$

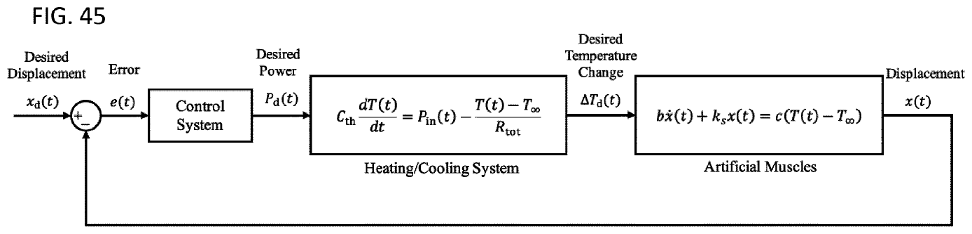

The mathematical models are beneficial in that they can be integrated into the control system that allows us to control how the TCA moves. This means that the more accurate the mathematical model is, the better control of the motion and displacement of the actuator within the channel. While portions of the mathematical model for the TCA and standard heating cooling systems already existed, the model that describes the heat transfer within the flexible fabric channel did not. Our work has focused on creating the equations that describe the heating/cooling system model. This can be seen in FIG. 45.

In FIG. 45, Cth the thermal capacity of TCAs, and Pin represents the electrical input power. T∞. and T are the ambient temperature and representative temperature of TCA, respectively. x is the displacement of TCAs from the equilibrium length in the ambient temperature to the current length, b and ks are the damping and spring stiffness coefficients of TCAs respectively, and c denotes the temperature coefficient. Finally, Rtot is the total thermal resistance calculated by considering the mechanical properties of the heating and cooling systems, including the parameters of the channel, fabric, and piezo blower. Note that the thermo-mechanical model, which presents a proportional relationship between the displacement and temperature of TCAs, as well as the thermo-electrical model, depicting the functionalities of heating and cooling systems, have already been established. The primary focus of this invention is the methods for computing the total thermal resistance of the system in order to enhance the optimization of the design procedure. Furthermore, this effort leads to the formulation of a precise control system for managing the system displacement, considering both the heating and cooling mechanisms.

An example of a control algorithm follows.

### Algorithm for the Control System:

### 1. Initialization:

Set the desired position x_{d}(t).
Measure the ambient temperature T_{∞}.
Initialize the current temperature T(t) and displacement x(t) of the TCA.
Set appropriate values for parameters: C, s, b, and c.

### 2. Temperature-Distance Estimation:

Use the thermo-mechanical model b\dot{x}(t)+kₛx(t)=c(T(t)−T_{∞}) to estimate the displacement x(t) of the TCA based on the current temperature.
Calculate the error as. e(t)=x_{d}(t)−x(t)
   3. Heating and Cooling Decisions (Assumes a TCA that Thermally Expands; for a TCA that Thermally Contracts Heating and Cooling Phases would be Reversed):
If e(t) is positive (meaning the length of actuator is shorter than desired), increase Pᵢₙ(t) to heat the TCA. (Heating Phase)
If e(t) is negative (meaning the length of actuator is longer than desired), activate the piezo blower to increase airflow in the fabric channel and cool the TCA. (Cooling Phase)

### 4. Thermal Dynamics Calculation:

### 4.1 Heating Dynamics:

When the system is in the heating phase:
The total thermal resistance during heating could be denoted as R_{tot,heat}
Calculate the temperature rate of change due to heating using:

$${C}_{th} \frac{dT ( t )}{dt} = {P}_{in} ( t ) - \frac{T ( t ) - {T}_{∞}}{{R}_{tot , heat}}$$

The above equation means the change in temperature depends on the power input (Pᵢₙ(t)) and the difference between the actuator current temperature and the ambient temperature, all divided by the total thermal resistance during heating.

### 4.2 Cooling Dynamics:

When the system is in the cooling phase:
The total thermal resistance during cooling could be denoted as R_{tot,cool}.
Calculate the temperature rate of change due to cooling using:

$${C}_{th} \frac{dT ( t )}{dt} = {P}_{in} ( t ) - \frac{T ( t ) - {T}_{∞}}{{R}_{tot , cool}}$$

Pin is 0 in the cooling phase. In this equation, a constant power input is considered for the cooling process to activate the piezo blower, as the temperature change is a function of the actuator current temperature relative to the ambient temperature, divided by the total thermal resistance during cooling.
   To improve cooling efficiency, the piezo blower activity level can be adjusted to regulate the airflow through the fabric channel, providing enhanced or reduced cooling as required.

Here these points should be considered:
estimate the values of R_{tot,heat} and R_{tot,cool} since they directly influence the rate of temperature change in the actuator.
switch between heating and cooling phases being smooth avoids abrupt changes that might cause wear and tear or reduce the lifespan of the actuator.
continuous monitoring of the actuator temperature will help in deciding when to switch between the heating and cooling phases, ensuring efficient control of the actuator position.

### 5. Feedback Loop:

Continuously monitor the actuator temperature T(t) and displacement x(t).
Adjust Pᵢₙ(t) based on the deviation of the actual displacement x(t) from the desired displacement x_{d}(t), taking into account the current temperature of the actuator and the ambient temperature.

### 6. Safety Checks:

Continuously check T(t) if is within a safe operating range for the actuator. If the temperature goes beyond this range, regulate Pᵢₙ(t) or the cooling mechanism accordingly to ensure the actuator does not get damaged.

### 7. Convergence Check:

Check if the error e(t) is within an acceptable threshold. If so, consider the actuator to be at its desired position and regulate Pᵢₙ(t) to maintain the current position.

### 8. End or Continue:

If the desired position is achieved and maintained, the control system can either be stopped or continue monitoring for any possible deviations.

### Experimental Example 8: Reference List

[1]J. Sun, et al., “Embedded and controllable shape morphing with twisted-and-coiled actuators,” in IEEE International Conference on Intelligent Robots and Systems, Madrid, Spain, 2018, pp. 5912-5917.
[2]M. T. Mason and I. Coleman, “Study of the surface emissivity of textile fabrics and materials in the 1 to 15 mu range,” Block Engineering Inc., Cambridge, MA, Tech. Rep., 1967.
[3]B. P. Edmonds, C. T. DeGroot, and A. L. Trejos, “Thermal modeling and characterization of twisted coiled actuators for upper limb wearable devices,” IEEE/ASME Transactions on Mechatronics, vol. 26, no. 2, pp. 966-977, 2020.
[4]V. K. Kothari and D. Bhattacharjee, “Prediction of thermal resistance of woven fabrics. Part I: Mathematical model,” Journal of the Textile Institute, vol. 99, no. 5, pp. 421-432, 2008.
[5]F. T. Peirce, “5 The geometry of cloth structure,” Journal of the Textile Institute Transactions, vol. 28, no. 3, pp. T45-T96, 1937.
[6]D. Bhattacharjee and V. K. Kothari, “Prediction of thermal resistance of woven fabrics. Part II: Heat transfer in natural and forced convective environments,” Journal of the Textile Institute, vol. 99, no. 5, pp. 433-449, 2008.
[7]F. M. Modest, “Radiative heat transfer,” 2nd edn., Academic Press, MA, USA, 2003.
[8]C. Mätzler, “MATLAB Functions for Mie scattering and absorption,” Institute of Applied Physics, University of Bern, Research Report, vol. 8.
[9]T. W. Tong and C. L. Tien, “Radiative heat transfer in fibrous insulations-Part I: Analytical study”, ASME J Heat Transfer, vol. 105, no. 1, pp. 70-75, 1983.
[10]P. W. Barber and S. C. Hill, “Light scattering by particles: Computational methods, scattering by infinite cylinder,” World Scientific, Singapore, 1990.

Several illustrative variants of an artificial muscle cooling apparatus, method or system have been described above. Further variants and modifications are described below. Moreover, guiding relationships for configuring variants and modifications are also described below. Still further variants and modifications are contemplated and will be recognized by the person of skill in the art. It is to be understood that guiding relationships and illustrative variants or modifications are provided for the purpose of enhancing the understanding of the person of skill in the art and are not intended as limiting statements.

Contemplated variation of an artificial muscle cooling apparatus, system or method can relate to features of: a flexible channel of tubular shape defining a lumen bound by a first end and a second end; an inlet interface attached to the first end of the flexible channel, at least a first port disposed in the inlet interface; an outlet formed by an opening at the second end of the flexible channel; an air flow device communicative with the at least first port disposed in the inlet interface. For example, the flexible channel is typically made of a fabric material. The fabric material may be characterized as being stitchable or sewable such that two or more portions of the flexible channel may be stitched or sewed together. A fabric or a textile is a cloth made from fibres, thin threads and/or filaments that are weaved, knitted and/or felted. The fabric may be part of a garment, so that the flexible channel is integrated or embedded in a garment. The fabric may be an integral or embedded part of a garment to be worn by a domesticated animal or human subject.

In some examples, the fabric material may be air-permeable. In other examples, the fabric material may be air-impermeable. Examples of the fabric material include nylon, polyester or polyurethane.

When the fabric material is selected to be air-permeable it may be defined by a breathability metric. Breathability can be measured through the permeability of the material. Permeability in fabrics, especially for breathable fabrics, typically refers to the ability of air and moisture to pass through them. For many applications, such as outdoor and athletic wear, this is essential for comfort as it can help regulate temperature and keep the wearer dry. Some common metrics used to measure the breathability of fabrics are as follows. 1. MVTR (Moisture Vapor Transmission Rate) which measures the amount of water vapor that can pass through a square meter of fabric in 24 hours. A breathable fabric would require an MVTR of 5,000 g/m\hat{ }2/day or higher. 2. RET (Resistance to Evaporative Heat Transfer) which measures breathability in terms of moisture evaporation resistance. A minimum RET of 13 would be needed to indicate breathability. 3. Air Permeability which measures amount of air that can pass through a fabric, usually reported in cubic feet per minute (CFM) or liters per second (L/s). It should have a value of 5 CFM or more. However, it should be noted that this measure is a function of the total area of the fabric, so standards should be followed when determining the value.

As another example of variation, the flexible channel may be made of parts that differ in material composition. For example, a portion of the flexible channel can be a manufactured thermoplastic polymer shaped as a partial pipe shape, for example manufactured by 3D printing soft foam in a partial pipe shape directly onto a flat or planar piece of fabric.

The partial pipe shaped portion, whether formed by 3D printed material or other manufacturing technique, must be flexible, and it should be a thermal insulator with a thermal conductivity of less than 1 W/mK (Watts per meter-Kelvin). The partial pipe piece is flexible and is configured to accommodate a desired amount of bending without failure. Therefore, the partial pipe piece will often be made of materials that confer flexibility in a manufactured product shape or form. For example, the partial pipe piece may typically be made of material characterized by a Young's Modulus lower than 2000 MPa. A generalization of a desired bending tolerance of a partial pipe piece is that it can sustain large deformations without failure or fracture or plastic deformation. For example, the partial pipe piece may be made of material characterized by an ultimate elongation between 200% and 2000%. Typically, the partial pipe piece will be more structurally robust than the fabric piece. Therefore, in many examples when the partial pipe piece and the fabric piece combine to form the flexible channel, the partial pipe piece will typically exhibit a greater stiffness relative to the fabric piece. The intended flexibility of the partial pipe piece is consistent with selection of materials that confer flexibility to a manufactured product, and therefore the partial pipe piece will typically made from thermoplastic polymers characterized by one or more of the desired properties relating to Young's Modulus, ultimate elongation, melting point, or thermal conductivity. Thermoset polymers will typically be avoided, as products made from thermoset polymers are often more brittle than products made from thermoplastic polymers. An example of a thermoplastic polymer is thermoplastic polyurethane.

As another example of variation, none of the flexible channel, the partial pipe piece or the fabric piece is limited by method of manufacture and any available method of manufacture may be used. For example, while the partial pipe piece has been described in Experimental Examples as being 3D printed directly into a flat fabric piece, other methods of manufacture for producing the partial pipe piece are contemplated. Available and contemplated methods of manufacture include, for example, vacuum molding, injection molding, blow molding, extrusion, casting and the like. Both additive and subtractive manufacturing techniques may be selected as may suit a particular implementation and scale of production.

As another example of contemplated variation, the flexible channel is made of a material having a melting point greater than 60 degrees Celsius. In a further example, the flexible channel is typically made of a material having a melting point greater than 70 degrees Celsius. In even further examples, the flexible channel is made of a material having a melting point greater than a temperature of 80, 90, 100, 110, 120, 130, 140, or 150 degrees Celsius or greater than any temperature therebetween.

As another example, the interior surface and/or the exterior surface of the flexible channel may be coated with a thermoplastic polymer. If the flexible channel, is made of two or more portions of material attached together a coating may be applied to material prior to attachment or after attachment once the flexible channel has been constructed. An example of a thermoplastic polymer is thermoplastic polyurethane.

As another example, the flexible channel may be perforated with a plurality of apertures, each of the plurality of apertures communicative between the lumen of the flexible channel and an exterior surface of the flexible channel. The plurality of apertures need not occur in any particular pattern or profile and may be applied specific to a particular implementation to achieve a desired air convection or air flow communication between the lumen and ambient air exterior to the flexible channel.

As another example of variation, at least a portion of the cross-sectional circumference of the flexible channel may be flattened or constructed to maintain a substantially flat shape. In such examples, at least a portion of the set of radial/transverse cross-sectional taken along the axial length of the flexible channel will show a circumference with a flat side. In some examples, the cross-sectional circumference of the flexible channel is a semi-circular or semi-elliptical shape. In other examples, the cross-sectional circumference of the flexible channel is a square shape. As another example of variation, the flexible channel is constructed from at least two parts of two differing manufactures or construction, a flexible partial pipe piece and a flexible fabric piece with a flat surface. The flexible partial pipe is formed with first and second opposing edges defining a longitudinal slot/opening, the first and second opposing edges of the partial pipe piece attach to the flat surface of the fabric piece to close the longitudinal slot/opening and define the lumen of the flexible channel. The flexible partial pipe piece presents an interior concave surface for defining a lumen to receive an artificial muscle, such as a TCA.

The concave surface may have a partial cylindrical shape or partial pipe shape with a C-shaped radial cross-section of various curvature lengths. The C-shaped radial cross-section can be considered as a partial circle, for example 10%, 15%, 20%, 25%, 30%, 35%, 40%, 45%, 50%, 55%, 60%, 65%, 70%, 75%, 80%, or any percentage therebetween of a full circle.

The concave surface has been shown as a smooth curve in cross-section. A concave surface made of straight sides is also contemplated, such as triangle, square or regular polygonal shapes. For example, the concave surface of a half pipe may typically consist of at least three straight sides, while a three quarter pipe may typically consist of at least five straight sides. Thus, polygonal approximations may be substituted for smooth circular C-shaped cross-sections. For example, a C-shaped cross-section may be modified to be any polygon having 5 or more sides such as a pentagon, hexagon, heptagon, octagon, nonagon, decagon and the like. Irregular polygons are also contemplated.

As another example of variation, the exterior surface of the flexible channel need not be matched to the shape of its lumen, and likewise the exterior surface of the flexible partial pipe piece need not be matched to the shape of its trough or C-shaped cross-section. For example, the exterior surface may have any triangular, square, circular or any regular or irregular polygonal shape independent of an interior concave surface of the flexible channel or partial pipe piece. However, the exterior surface of the flexible channel will typically present at least one flat side for ease of attachment to a platform such as a robotic substrate, object, or accessory. Similarly, the partial pipe piece typically defines a longitudinal slot/opening closed by a fabric piece to define a flat surface for attachment to a platform. In certain examples, the platform may be a flat fabric piece that is commonly attached to a plurality of partial pipe pieces arranged at different positions of the flat fabric piece.

As another example, the inlet interface at least partial covers or at least partially closes the first end of the flexible channel. In an example, the inlet interface is formed as a plate structure or a cap structure that at least partially covers or closes the first end. In some examples, the inlet interface forms a sealed cap or closure of the first end of the flexible channel. In other examples, the inlet interface attachment to the first end of the flexible channel provides at least one gap for communication of ambient air from an exterior of the flexible channel with the lumen of the flexible channel. In further examples, the inlet interface is modular and comprises a central piece mating with a circumferential piece, the central piece housing the at least first port. In still further examples, the inlet interface is configured with a port for receiving an artificial muscle fibre and/or electrical leads for actuating the artificial muscle fibre. In yet further examples, the inlet interface is configured with a port for receiving leads for a temperature sensor. In yet other examples, the inlet interface is configured with a port for receiving leads for electrical heating of the artificial muscle fibre. As another example, disposition of an artificial muscle fibre within the flexible channel may be varied. Typically, the artificial muscle fibre is disposed within the lumen with cross-sectional circumference of the artificial muscle fibre being fully contained within the tubular shape of the flexible channel. In certain examples, a central axis of the artificial muscle fibre is substantially co-axial with a central axis of the flexible channel when the artificial muscle fibre is in a neutral unheated stated. In other examples, an axial length of the artificial muscle fibre is substantially co-extensive with an axial length of the flexible channel when the artificial muscle fibre is in a neutral unheated stated.

As another example, variation of the artificial muscle fibre is contemplated. The cooling channel may benefit any artificial muscle fibre that generates heat regardless of the actuating or activation mechanism requiring heat. In some examples, the artificial muscle fibre is a thermally activated muscle fibre. In such examples, thermally activated artificial muscles are typically a type of artificial muscles characterized by transitioning from an equilibrium or neutral state to an activated state upon heating. Typically, the equilibrium or neutral state corresponds to a fully extended position of the axial length of the thermally activated artificial muscle and the activated state corresponds to a contracted position of the axial length of the thermally activated artificial muscle; more generally a thermally activated artificial muscle fibre typically transitions or moves from an extended axial length to a contracted axial length upon heating. In certain examples, the artificial muscle fibre is SMA. In other examples, the artificial muscle fibre is TCA. In further examples, a plurality of artificial muscle fibres are disposed within the lumen with cross-sectional circumference of each of the plurality of artificial muscle fibres being fully contained within the tubular shape of the flexible channel.

As another example, the air flow device may be varied to suit a particular implementation. Air flow devices are often categorized as an air fan, air blower, or air compressor. The term air pump is an imprecise term in its conventional use and depending on context of its use may reference an air blower or air compressor. In certain examples, the air flow device is an air fan. In other examples, the air flow device is an air blower. In other examples, the air flow device is an air pump. In further examples, the air flow device is an air compressor.

The utility of the cooling system follows any desired implementation of artificial muscles fibres. In some examples, the cooling system is incorporated in a robotic device. In certain examples, the robotic device is a wearable robotic device. In other examples, the wearable robotic device provides robotic rehabilitation therapy.

The cooling system may accommodate various controller types and controller algorithms to control cooling of an artificial muscle and optionally control thermal actuation of an artificial muscle. For example, proportional-integrative-derivative (PID), proportional-integrative (PI) or proportional (P) algorithms may be used to control the cooling system depending on parameters of a specific implementation. In various examples, the controller is a hybrid PID controller, a Smith predictor controller, a Kalman filter controller, Adaptive controller, Robust controller, Intelligent controller, Linear controller, non-Linear controller or any combination thereof.

The computer-implemented control of the cooling system typically requires a memory, an interface and a processor. The types and arrangements of memory, interface and processor may be varied according to implementations. For example, the interface may include a software interface that communicates with an end-user computing device. The interface may also include a physical electronic device configured to receive requests or queries from an end-user.

Although a microprocessor or microcontroller was used in experiments described above, many other computer device types may be used including for example, a programmable logic controller or a field programmable logic/gate array. Moreover, any conventional computer architecture may be used for computer-implemented control of the cooling system including for example a memory, a mass storage device, a processor (CPU), a Read-Only Memory (ROM), and a Random-Access Memory (RAM) generally connected to a system bus of data-processing apparatus. Memory can be implemented as a ROM, RAM, a combination thereof, or simply a general memory unit. Software modules in the form of routines and/or subroutines for carrying out features of the cooling system for targeting a desired temperature of an artificial muscle can be stored within memory and then retrieved and processed via processor to perform a particular task or function. Similarly, one or more compensation algorithms may be encoded as a program component, stored as executable instructions within memory and then retrieved and processed via a processor. A user input device, such as a keyboard, mouse, or another pointing device, can be connected to PCI (Peripheral Component Interconnect) bus. The software will typically provide an environment that represents programs, files, options, and so forth by means of graphically displayed icons, menus, and dialog boxes on a computer monitor screen.

A data-process apparatus can include CPU, ROM, and RAM, which are also coupled to a PCI (Peripheral Component Interconnect) local bus of data-processing apparatus through PCI Host Bridge. The PCI Host Bridge can provide a low latency path through which processor may directly access PCI devices mapped anywhere within bus memory and/or input/output (I/O) address spaces. PCI Host Bridge can also provide a high bandwidth path for allowing PCI devices to directly access RAM.

A communications adapter, a small computer system interface (SCSI), and an expansion bus-bridge may also be attached to PCI local bus. The communications adapter can be utilized for connecting data-processing apparatus to a network. SCSI can be utilized to control a high-speed SCSI disk drive. An expansion bus-bridge, such as a PCI-to-ISA bus bridge, may be utilized for coupling ISA bus to PCI local bus. PCI local bus can be connected to a monitor, which functions as a display (e.g., a video monitor) for displaying data and information for an operator and also for interactively displaying a graphical user interface.

Computer-implemented control of the cooling system may accommodate any type of end-user computing device including computing devices communicating over a networked connection. The computing device may display graphical interface elements for performing the various functions of the system such as selecting a pre-set desired temperature setting, a pre-set desired displacement setting, a pre-set desired power setting, selecting a control algorithm, modifying an existing temperature or displacement or power setting or an existing control algorithm, or updating a database of an activity log that may be locally stored in the computing device. For example, the computing device may be a desktop, laptop, notebook, tablet, personal digital assistant (PDA), PDA phone or smartphone, gaming console, portable media player, and the like. The computing device may be implemented using any appropriate combination of hardware and/or software configured for wired and/or wireless communication. Communication can occur over a network, for example, where remote control or remote monitoring of the cooling system is desired.

If a networked connection is desired the cooling system and its controlling system may accommodate any type of network. The network may be a single network or a combination of multiple networks. For example, the network may include the internet and/or one or more intranets, landline networks, wireless networks, and/or other appropriate types of communication networks. In another example, the network may comprise a wireless telecommunications network (e.g., cellular phone network) adapted to communicate with other communication networks, such as the Internet. For example, the network may comprise a computer network that makes use of a TCP/IP protocol (including protocols based on TCP/IP protocol, such as HTTP, HTTPS or FTP).

The cooling system described herein and each variant, modification or combination thereof may be controlled by a suitable computer-implemented method. In one example, a method of controlling the cooling system includes detecting real-time temperature data with a temperature sensor installed in or on the flexible channel; receiving the real-time temperature data, estimating a displacement of the artificial muscle based on the real-time temperature data and an estimated thermal resistance, and generating and communicating a control signal to adjust power input to minimize a difference between the estimated displacement and a preset desired displacement during an operational actuation of the artificial muscle. In certain examples, the estimated thermal resistance is a total thermal resistance of the artificial muscle, air in the lumen, the flexible channel, and the ambient air. In other examples, estimating the displacement is based on determining a difference between a real-time temperature and a measured ambient temperature.

The cooling system described herein and each variant, modification or combination thereof may also be implemented as a method or computer programmable/readable code on a non-transitory computer readable medium (i.e. a substrate). The computer readable medium is a data storage device that can store data, which can thereafter, be read by a computer system. Examples of a computer readable medium include read-only memory, random-access memory, CD-ROMs, magnetic tape, SD card, optical data storage devices and the like. The computer readable medium may be geographically localized or may be distributed over a network coupled computer system so that the computer readable code is stored and executed in a distributed fashion.

Embodiments described herein are intended for illustrative purposes without any intended loss of generality. Still further variants, modifications and combinations thereof are contemplated and will be recognized by the person of skill in the art. Accordingly, the foregoing detailed description is not intended to limit scope, applicability, or configuration of claimed subject matter.

1.-62. (canceled)

63. A cooling system for an artificial muscle, comprising:
a flexible channel of tubular shape defining a lumen bound by a first end and a second end;
an inlet interface attached at or near the first end of the flexible channel, at least a first port disposed in the inlet interface;
an outlet formed by an opening at the second end of the flexible channel;
an air flow device communicative with the at least first port disposed in the inlet interface;
a temperature sensor mounted to the flexible channel and configured to detect real-time temperature data;
a controller configured to receive the real-time temperature data, estimate a displacement of an artificial muscle based on the real-time temperature data and an estimated thermal resistance, and communicate a control signal to adjust power input to minimize a difference between the estimated displacement and a preset desired displacement during an operational actuation of the artificial muscle.

64. The cooling system of claim 63, wherein the estimated thermal resistance is a total thermal resistance of the artificial muscle, air in the lumen, the flexible channel, and the ambient air.

65. The cooling system of claim 63, wherein estimating the displacement is based on determining a difference between a real-time temperature and a measured ambient temperature.

66. The cooling system of claim 63, wherein the controller is a proportional-derivative-integral (PID) controller, a hybrid PID controller, a Smith predictor controller, a Kalman filter controller, Adaptive controller, Robust controller, Intelligent controller, Linear controller, non-Linear controller or any combination thereof.

67. The cooling system of claim 63, wherein the temperature sensor is an infrared sensor.

68. The cooling system of claim 63, wherein the flexible channel is made of a flexible fabric material having a melting point greater than 80 degrees Celsius.

69. The cooling system of claim 63, wherein an exterior surface of the flexible channel is coated with a thermoplastic polymer.

70. The cooling system of claim 63, wherein the flexible channel is perforated with a plurality of apertures, each of the plurality of apertures communicative between the lumen of the flexible channel and an exterior surface of the flexible channel.

71. The cooling system of claim 63, wherein at least a portion of the cross-sectional circumference of the flexible channel is flattened.

72. The cooling system of claim 63, wherein the cross-sectional circumference of the flexible channel is a semi-circular or semi-elliptical shape.

73. The cooling system of claim 63, wherein the inlet interface is formed as a platform integrated with an exterior surface of the flexible channel, and the first port is offset from the lumen of the flexible channel.

74. The cooling system of claim 63, wherein the inlet interface attachment to the first end of the flexible channel provides at least one gap for communication of ambient air from an exterior of the flexible channel with the lumen of the flexible channel.

75. The cooling system of claim 63, wherein the inlet interface is modular and comprises a central piece mating with a circumferential piece, the central piece housing the at least first port.

76. The cooling system of claim 63, further comprising an artificial muscle fiber disposed within the lumen with cross-sectional circumference of the artificial muscle fiber being fully contained within the tubular shape of the flexible channel.

77. The cooling system of claim 76, wherein a central axis of the artificial muscle fiber is substantially co-axial with a central axis of the flexible channel when the artificial muscle fiber is in a neutral unheated stated.

78. The cooling system of claim 76, wherein an axial length of the artificial muscle fiber is substantially co-extensive with an axial length of the flexible channel when the artificial muscle fiber is in a neutral unheated stated.

79. The cooling system of claim 76, wherein the artificial muscle fiber is a twisted coiled actuator.

80. The cooling system of claim 76, wherein a plurality of artificial muscle fibers are disposed within the lumen with cross-sectional circumference of each of the plurality of artificial muscle fibers being fully contained within the tubular shape of the flexible channel.

81. The cooling system of claim 63 incorporated in a robotic device.

82. The cooling system of claim 81, wherein the robotic device is a wearable robotic device.
